(19) United States
(12) Patent Application Publication
(10) Pub. No.: US 2026/0296017 A1
(43) Pub. Date: Oct. 1, 2026

(54) Liquid Ejecting Apparatus

(71) Applicant: SEIKO EPSON CORPORATION, Tokyo (JP)

(72) Inventor: Eiichiro WATANABE, Matsumoto (JP)

(21) Appl. No.: 19/578,194

(22) Filed: Mar. 25, 2026

(30) Foreign Application Priority Data
Mar. 26, 2025 (JP) 2025-051840

(51) Int. Cl. B41J 2/15; B41J 25/00

(52) U.S. Cl. CPC B41J 2/15; B41J 25/005

(57) ABSTRACT

A liquid ejecting apparatus includes a liquid ejecting head including a plurality of nozzle arrays in which a plurality of nozzles are arranged in a nozzle array direction, a transport mechanism that transports a medium in a first direction, and an air blowing mechanism, in which the nozzle array direction intersects both the first direction and a second direction orthogonal to both the first direction and an ejection direction, and the air blowing mechanism generates an airflow in a third direction intersecting all of the first direction, the second direction, and the nozzle array direction.

The present application is based on, and claims priority from JP Application Serial Number 2025-051840, filed Mar. 26, 2025, the disclosure of which is hereby incorporated by reference herein in its entirety.

### BACKGROUND

### 1. Technical Field

The present disclosure relates to a liquid ejecting apparatus.

### 2. Related Art

In the related art, a technique for ejecting liquid such as ink from a plurality of nozzles to a medium such as printing paper is proposed. For example, JP-A-2016-55476 discloses a liquid ejecting apparatus in which a nozzle array direction in which a nozzle array in which a plurality of nozzles are linearly disposed extends is inclined with respect to a transport direction of a medium.

However, in the liquid ejecting apparatus in the related art, the nozzle array direction is inclined with respect to the transport direction, and thus there is a concern that there are variations in a position at which the liquid lands on the medium.

### SUMMARY

According to an aspect of the present disclosure, a liquid ejecting apparatus includes: a liquid ejecting head having an ejection surface including a plurality of nozzle arrays in which a plurality of nozzles that eject liquid in an ejection direction are arranged in a nozzle array direction; a transport mechanism that transports a medium in a first direction at a position facing the ejection surface; and an air blowing mechanism, in which the nozzle array direction intersects both the first direction and a second direction orthogonal to both the first direction and the ejection direction, and the air blowing mechanism generates an airflow along the ejection surface in a third direction intersecting all of the first direction, the second direction, and the nozzle array direction.

According to another aspect of the present disclosure, a liquid ejecting apparatus includes: a liquid ejecting head including a plurality of head chips each including a nozzle group including a plurality of nozzles that eject liquid in an ejection direction; a transport mechanism that transports a medium in a first direction at a position facing an ejection surface of the liquid ejecting head; and an air blowing mechanism, in which the plurality of nozzles include a plurality of used nozzles used for a printing operation of ejecting the liquid toward the medium, when a region surrounded by a smallest convex polygon surrounding the plurality of used nozzles in each of a plurality of the nozzle groups is defined as a nozzle region, a plurality of the nozzle regions corresponding to the plurality of nozzle groups are each elongated in a fourth direction intersecting both the first direction and a second direction orthogonal to both the first direction and the ejection direction, and the air blowing mechanism generates an airflow along the ejection surface in a third direction intersecting all of the first direction, the second direction, and the fourth direction.

### BRIEF DESCRIPTION OF THE DRAWINGS

FIG. 1 is an explanatory diagram illustrating an example of a liquid ejecting apparatus according to a first embodiment.

FIG. 2 is a perspective view of a head module.

FIG. 3 is a view of a plurality of liquid ejecting heads when viewed in a Z1 direction.

FIG. 4 is an exploded perspective view of the liquid ejecting head.

FIG. 5 is an exploded perspective view of a head chip.

FIG. 6 is a cross-sectional view taken along line VI-VI in FIG. 5.

FIG. 7 is a view of the head module when viewed in an X1 direction.

FIG. 8 is a cross-sectional view taken along line VIII-VIII in FIG. 7.

FIG. 9 is a cross-sectional view taken along line IX-IX in FIG. 2.

FIG. 10 is a diagram illustrating a blowing direction of an air blowing mechanism.

FIG. 11 is a diagram illustrating a blowing direction of an air blowing mechanism in a second embodiment.

FIG. 12 is a diagram illustrating a blowing direction of an air blowing mechanism in a first modification example.

FIG. 13 is a diagram illustrating a blowing direction of an air blowing mechanism in a second modification example.

FIG. 14 is a diagram illustrating a blowing direction of an air blowing mechanism in a third modification example.

FIG. 15 is a diagram illustrating a blowing direction of an air blowing mechanism in a fourth modification example.

FIG. 16 is a diagram illustrating the blowing direction of the air blowing mechanism in the fourth modification example.

FIG. 17 is an explanatory diagram illustrating an example of a liquid ejecting apparatus in a fifth modification example.

FIG. 18 is a diagram illustrating a blowing direction of an air blowing mechanism in the fifth modification example.

FIG. 19 is a diagram illustrating a blowing direction of an air blowing mechanism in a seventh modification example.

### DESCRIPTION OF EMBODIMENTS

Hereinafter, embodiments for carrying out the present disclosure will be described with reference to the accompanying drawings. However, in each of the drawings, the dimension and scale of each section may differ as appropriate from the actual dimension and scale. In addition, the embodiments described below are preferred specific examples of the present disclosure, and thus include various technically preferable limitations, but the scope of the present disclosure is not limited to these embodiments unless otherwise specified as limiting the present disclosure in the following description.

### 1. First Embodiment

### 1-1. Overview of Liquid Ejecting Apparatus 100

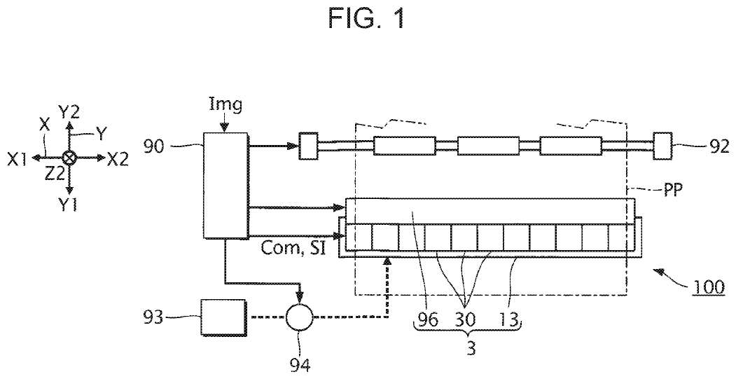

FIG. 1 is an explanatory diagram illustrating an example of a liquid ejecting apparatus 100 according to a first embodiment. The liquid ejecting apparatus 100 according to the present embodiment is an ink jet type printing apparatus that ejects ink that is an example of liquid as droplets onto a medium PP. The liquid ejecting apparatus 100 according to the present embodiment is a so-called line type printing apparatus in which a plurality of nozzles N that eject the ink are distributed over an entire range in a width direction of the medium PP. The medium PP is, for example, printing paper, but any printing target, such as a resin film or cloth, can be used as the medium PP.

As illustrated in FIG. 1, the liquid ejecting apparatus 100 includes a liquid container 93 for storing the ink. As the liquid container 93, for example, a cartridge attachable to and detachable from the liquid ejecting apparatus 100, a bag-shaped ink pack formed of a flexible film, or an ink tank in which the ink can be replenished can be adopted. One or a plurality of types of the ink are stored in the liquid container 93.

As illustrated in FIG. 1, the liquid ejecting apparatus 100 includes a head module 3 having a plurality of liquid ejecting heads 30, a control device 90, a transport mechanism 92, and a circulation mechanism 94. The control device 90 includes, for example, a processing circuit such as a CPU or an FPGA and a storage circuit such as a semiconductor memory, and controls each element of the liquid ejecting apparatus 100. Here, “CPU” is an abbreviation for a central processing unit, and “FPGA” is an abbreviation for a field programmable gate array.

The transport mechanism 92 transports the medium PP in a Y1 direction under the control of the control device 90.

Hereinafter, the Y1 direction and a Y2 direction opposite to the Y1 direction may be collectively referred to as a direction along a Y axis.

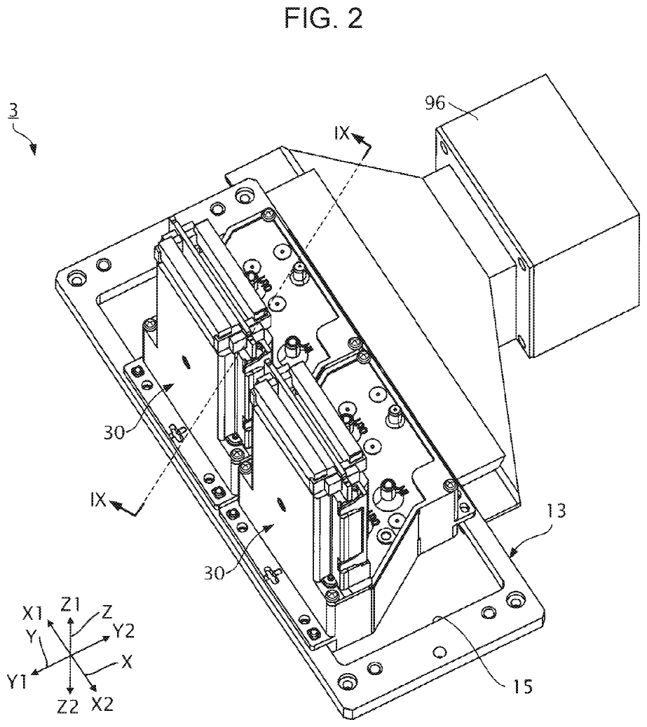

The head module 3 ejects the ink supplied from the liquid container 93 in a Z2 direction under the control of the control device 90. The Z2 direction is a direction orthogonal to the Y1 direction. Hereinafter, the Z2 direction and a Z1 direction opposite to the Z2 direction may be collectively referred to as a direction along a Z axis. The head module 3 will be described with reference to FIG. 2.

### 1-2. Head Module 3

FIG. 2 is a perspective view of the head module 3. The head module 3 includes the plurality of liquid ejecting heads 30, a head fixing substrate 13 that holds the plurality of liquid ejecting heads 30, and an air blowing mechanism 96. In FIG. 2, in order to prevent the drawing from being complicated, an example is illustrated in which the number of the liquid ejecting heads 30 included in the head module 3 is two.

The plurality of liquid ejecting heads 30 are arranged in an X1 direction and an X2 direction that are orthogonal to the Y1 direction that is the transport direction, and are fixed to the head fixing substrate 13. The X2 direction is opposite to the X1 direction. Hereinafter, the X1 direction and the X2 direction may be collectively referred to as a direction along the X axis. The head module 3 is a line head including the plurality of liquid ejecting heads 30 disposed such that the plurality of nozzles N are distributed over the entire range of the medium PP in a direction along the X axis. That is, the plurality of liquid ejecting heads 30 constitute a line head of which a longitudinal direction is the direction along the X axis. By ejecting the ink from the plurality of liquid ejecting heads 30 in parallel with the transport of the medium PP by the transport mechanism 92, an image using the ink is formed on the surface of the medium PP. The head module 3 may be a line head that is elongated in a direction in which the X axis extends and that includes only a single liquid ejecting head 30 disposed such that the plurality of nozzles N are distributed over the entire range of the medium PP in the direction along the X axis. The head fixing substrate 13 includes a plurality of mounting holes 15 for mounting the liquid ejecting head 30. The liquid ejecting head 30 is supported by the head fixing substrate 13 in a state where the liquid ejecting head 30 is inserted into the mounting hole 15. FIG. 2 illustrates the head fixing substrate 13 as a plate-shaped member, but the head fixing substrate 13 may have a shape other than the plate shape.

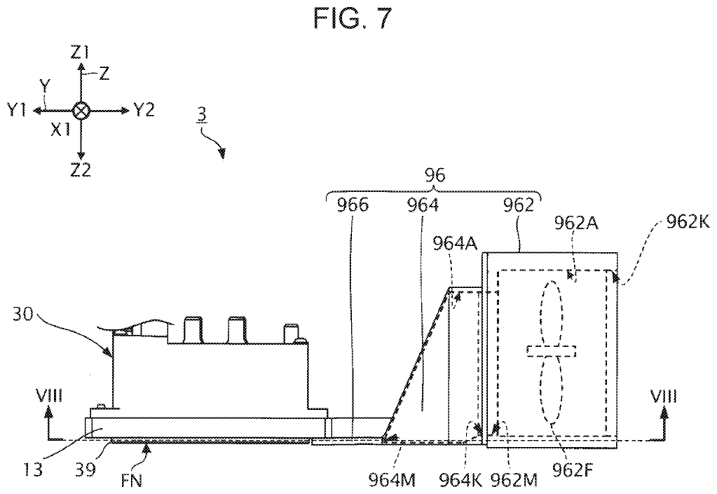

The air blowing mechanism 96 blows air between the medium PP and the liquid ejecting head 30 under the control of the control device 90. In the example of FIG. 2, the air blowing mechanism 96 is installed in the Y2 direction with respect to the liquid ejecting head 30. In addition, the air blowing mechanism 96 will be described below with reference to FIGS. 7 to 9.

The description will return to FIG. 1. The transport mechanism 92 transports the medium PP in the direction along the Y axis with respect to the head module 3. In the example illustrated in FIG. 1, the liquid container 93 is coupled to the head module 3 via the circulation mechanism 94. The circulation mechanism 94 is a mechanism for supplying the ink to each of the plurality of liquid ejecting heads 30 and collecting the ink discharged from each of the plurality of liquid ejecting heads 30 for resupplying the ink to the liquid ejecting heads 30. The circulation mechanism 94 includes, for example, a sub tank for storing the ink, a flow path for supplying the ink from the sub tank to the liquid ejecting heads 30, a flow path for collecting the ink from the liquid ejecting heads 30 to the sub tank, and a pump for causing the ink to flow as appropriate. By the operation of the circulation mechanism 94, it is possible to suppress an increase in the viscosity of the ink or to reduce the retention of air bubbles in the ink.

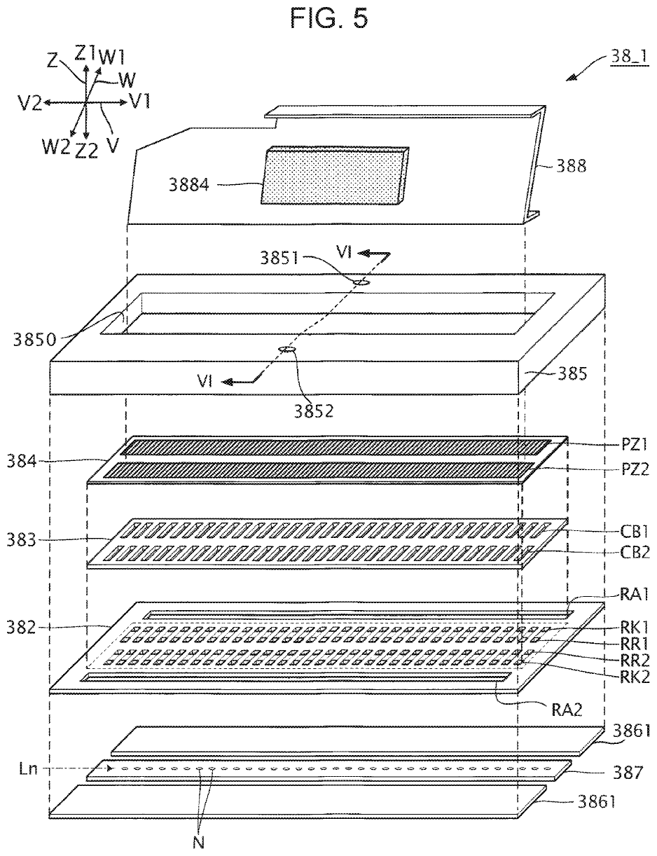

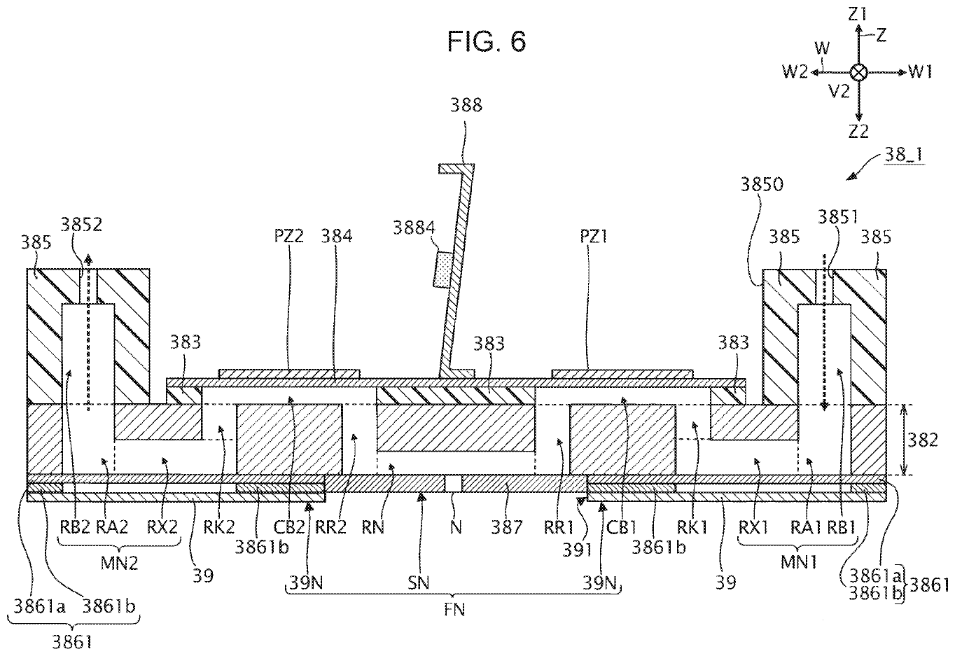

The control device 90 receives print data Img indicating an image to be formed by the liquid ejecting apparatus 100 from a host computer such as a PC or a digital camera. When the print data Img is received, a drive signal Com for driving the liquid ejecting head 30 and a control signal SI for controlling the liquid ejecting head 30 are supplied to the liquid ejecting head 30 from the control device 90. Then, the liquid ejecting head 30 is driven by the drive signal Com under the control of the control signal SI, and executes a printing operation of forming the image indicated by the print data Img on the medium PP by ejecting the ink in the Z2 direction from some or all of the plurality of nozzles N provided in the liquid ejecting head 30. The nozzle N will be described below in FIGS. 5 and 6.

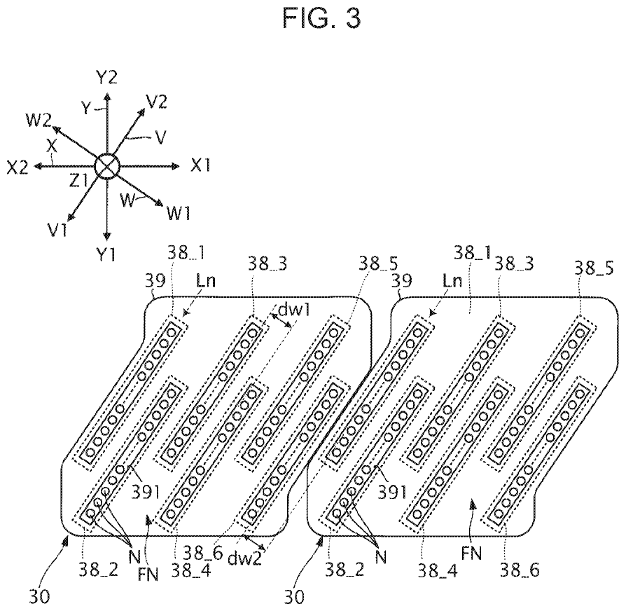

FIG. 3 is a diagram of the plurality of liquid ejecting heads 30 when viewed in the Z1 direction. Each of the plurality of liquid ejecting heads 30 includes a plurality of head chips 38 and a fixing plate 39. In the first embodiment, one liquid ejecting head 30 includes six head chips 38_1, 38_2, 38_3, 38_4, 38_5, and 38_6. Hereinafter, these head chips 38_1, 38_2, 38_3, 38_4, 38_5, and 38_6 will be described as the head chip 38 when there is no need of distinction.

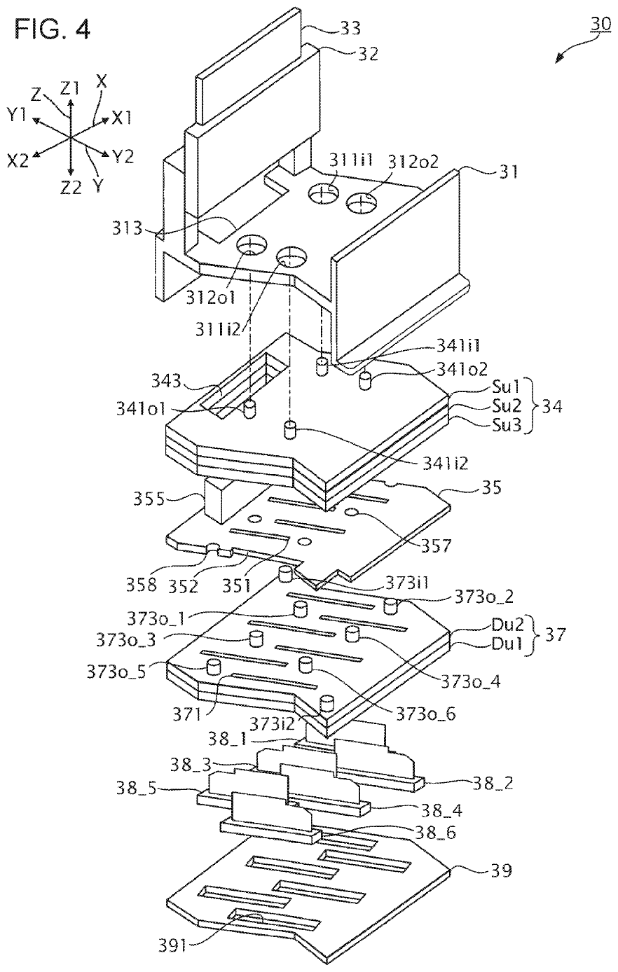

The fixing plate 39 is a plate member for fixing each of the plurality of head chips 38 to a holder 37 illustrated in FIG. 4.

The plurality of head chips 38 are disposed to extend in a V2 direction. The V2 direction is a direction perpendicular to the direction along the Z axis and intersecting the direction along the X axis and the direction along the Y axis, and is a direction between the X1 direction and the Y2 direction. A direction opposite to the V2 direction is referred to as a V1 direction. Furthermore, the V1 direction and the V2 direction may be collectively referred to as a direction along a V axis. Furthermore, a direction perpendicular to the direction along the Z axis and the direction along the V axis is referred to as a W1 direction and a W2 direction. The W1 direction is a direction between the X1 direction and the Y1 direction, and the W2 direction is a direction between the X2 direction and the Y2 direction. The W1 direction and the W2 direction may be collectively referred to as a direction along a W axis.

Each of the plurality of head chips 38 includes a nozzle array Ln. The nozzle array Ln includes M nozzles N that are arranged in the V2 direction. M is an integer of 2 or more.

As illustrated in FIG. 3, in the first embodiment, an ejection surface FN that is a surface of one liquid ejecting head 30 facing the Z2 direction includes six nozzle arrays Ln. As illustrated in FIG. 3, the six nozzle arrays Ln are arranged in the direction along the X axis. As illustrated in FIG. 3, in the six nozzle arrays Ln, two adjacent nozzle arrays Ln at least partially overlap each other when viewed in the Y1 direction. For example, when viewed in the Y1 direction, all of the nozzle array Ln included in the head chip 38_1 and the nozzle array Ln included in the head chip 38_2 overlap each other. When viewed in the Y1 direction, the nozzle array Ln included in the head chip 38_1 and the nozzle array Ln included in the head chip 38_2 may almost completely overlap each other by being shifted from each other in the direction along the X axis by half of a pitch of the nozzles N of the nozzle array Ln in the direction along the X axis. Accordingly, the resolution in the direction along the X axis can be increased by supplying the same type of the ink to the head chips 38_1 and 38_2. When viewed in the Y1 direction, the overlapping manner of the head chips 38_3 and 38_4 and the overlapping manner of the head chips 38_5 and 38_6 need only be the same as the overlapping manner of the head chips 38_1 and 38_2.

In addition, when viewed in the Y1 direction, a part of the nozzle array Ln included in the head chip 38_2 and a part of the nozzle array Ln included in the head chip 38_3 overlap each other, and a part of the nozzle array Ln included in the head chip 38_4 and a part of the nozzle array Ln included in the head chip 38_5 overlap each other.

Further, when viewed in the Y1 direction, a part of the nozzle array Ln included in the head chip 38_1 and a part of the nozzle array Ln included in the head chip 38_3 overlap each other, and a part of the nozzle array Ln included in the head chip 38_3 and a part of the nozzle array Ln included in the head chip 38_5 overlap each other. Therefore, when the same type of the ink is ejected from the head chips 38_1, 38_3, and 38_5, the nozzle arrays Ln of the head chips 38_1, 38_3, and 38_5 can be regarded as one nozzle array arranged in the direction substantially along the X axis. The same applies to the head chips 38_2, 38_4, and 38_6.

In the first embodiment, an interval dw1 in the W axis between the two nozzle arrays Ln adjacent in the W axis within one liquid ejecting head 30 is substantially the same for all cases. The expression “substantially the same” includes not only cases where elements are completely the same, but also cases that can be regarded as the same in consideration of manufacturing tolerances. In addition, an interval dw2 in the W axis between the nozzle arrays Ln of the two liquid ejecting heads 30 adjacent in the X axis is substantially the same as the interval dw1. However, the interval dw2 may be narrower than the interval dw1 by disposing the two liquid ejecting heads 30 adjacent in the X axis at a closer interval.

Here, as can be understood from FIG. 3, the “interval between the two nozzle arrays Ln adjacent in the W axis” refers to, when one nozzle array Ln is disposed in the W2 direction relative to the other nozzle array Ln, a distance in the direction along the W axis between an end in the W1 direction of an inner edge of an opening of the nozzle N of one nozzle array Ln and an end in the W2 direction of the inner edge of the opening of the nozzle N of the other nozzle array Ln in the W1 direction.

### 1-3. Liquid Ejecting Head 30

FIG. 4 is an exploded perspective view of the liquid ejecting head 30. The liquid ejecting head 30 includes a housing 31, a cover substrate 32, an aggregate substrate 33, a flow path structure 34, a wiring substrate 35, the holder 37, the plurality of head chips 38, and the fixing plate 39.

The flow path structure 34 includes flow path plates Su1 to Su3, coupling pipes 341i1, 341i2, 341o1, and 341o2, and a connector hole 343.

The holder 37 includes flow path members Du1 and Du2 and coupling pipes 373i1, 373i2, and 373o_1 to 373o_6. Hereinafter, these coupling pipes 373i1, 373i2, and 373o_1 to 373o_6 will be collectively referred to as coupling pipes 373. Further, the holder 37 includes six opening portions 371 penetrating in the direction along the Z axis.

The housing 31 supports the flow path structure 34, the wiring substrate 35, the holder 37, and the fixing plate 39. Furthermore, the housing 31 includes supply holes 311i1 and 311i2, discharge holes 312o1 and 312o2, and an aggregate substrate hole 313. The coupling pipe 341i1 is inserted into the supply hole 311i1. The coupling pipe 341i2 is inserted into the supply hole 311i2. The coupling pipe 341o1 is inserted into the discharge hole 312o1. The coupling pipe 341o2 is inserted into the discharge hole 312o2. The aggregate substrate 33 is inserted into the aggregate substrate hole 313.

The cover substrate 32 holds the aggregate substrate 33 between the cover substrate 32 and a portion of the housing 31 extending in the Z1 direction. The aggregate substrate 33 is a substrate on which a wiring for transmitting the drive signal Com and the control signal SI supplied from the control device 90 to each of the plurality of head chips 38 is formed. The aggregate substrate 33 is a plate-shaped member extending parallel to an XZ plane. Here, the expression “parallel” is a concept that includes not only cases where elements are completely parallel, but also cases that can be regarded as parallel in consideration of errors that may occur due to manufacturing tolerances of the liquid ejecting head 30, even when elements are designed to be parallel.

The flow path structure 34 is a structure in which a flow path for causing the ink to flow between the circulation mechanism 94 and each of the plurality of head chips 38 is provided. The flow path structure 34 is disposed between the housing 31 and the wiring substrate 35. The flow path plates Su1 to Su3 included in the flow path structure 34 are laminated in this order in the Z1 direction. A connector 355 of the wiring substrate 35 is inserted into the connector hole 343.

The coupling pipes 341i1 and 341i2 introduce the ink supplied from the liquid container 93 into the holder 37. The coupling pipes 341o1 and 341o2 discharge the ink discharged from the holder 37 to the outside of the liquid ejecting head 30.

The wiring substrate 35 is a mounting component for electrically coupling the liquid ejecting head 30 to the control device 90. The wiring substrate 35 is a substrate on which a wiring for transmitting various control signals and power supply voltages to the head chip 38 is formed. The wiring substrate 35 is a plate-shaped member extending parallel to the XY plane, and is disposed between the flow path structure 34 and the holder 37. The wiring substrate 35 is, for example, a rigid substrate. The wiring substrate 35 includes the connector 355, four opening portions 351 and two notch portions 352, four opening portions 357, and two notch portions 358. As illustrated in FIG. 4, the four opening portions 351 and the two notch portions 352 are arranged in a staggered manner. The connector 355 is inserted into the connector hole 343, and electrically coupled to the aggregate substrate 33.

Any one of the coupling pipes 373o_1, 373o_3, 373o_4, and 373o_6 is inserted into each of the four opening portions 357. Any one of the coupling pipes 373o_2 and 373o_5 is inserted into the two notch portions 358.

The holder 37 is disposed between the wiring substrate 35 and the fixing plate 39, and is fixed to the fixing plate 39 by an adhesive. Therefore, the holder 37 reinforces the fixing plate 39. The holder 37 is a structure in which a flow path for causing the ink to flow between the circulation mechanism 94 and each of the plurality of head chips 38 is provided. The flow path members Du1 and Du2 included in the holder 37 are laminated in this order in the Z1 direction. The holder 37 is made of, for example, a resin or a metal. The holder 37 has a recess portion (not illustrated) for housing the plurality of head chips 38 on the surface on the Z2 direction side, and holds the plurality of head chips 38 such that the plurality of head chips 38 are disposed between the recess portion and the fixing plate 39.

The coupling pipe 373i1 communicates with any one of a plurality of discharge ports (not illustrated) formed on a surface of the flow path structure 34 in the Z2 direction, and introduces the ink from the flow path structure 34 into the holder 37. The ink introduced into the holder 37 is distributed within the holder 37, and supplied to the head chips 38_1, 38_3, and 38_5. The ink discharged from the head chips 38_1, 38_3, and 38_5 is introduced into the holder 37. The coupling pipes 373o_1, 373o_3, and 373o_5 communicate with any one of a plurality of inlets (not illustrated) formed on a surface of the flow path structure 34 in the Z2 direction, and introduce the ink from the holder 37 into the flow path structure 34.

The coupling pipe 373i2 communicates with any one of the plurality of discharge ports (not illustrated) formed on the surface of the flow path structure 34 in the Z2 direction, and introduces the ink from the flow path structure 34 into the holder 37. The ink introduced into the holder 37 is distributed within the holder 37, and supplied to the head chips 38_2, 38_4, and 38_6. The ink discharged from the head chips 38_2, 38_4, and 38_6 is introduced into the holder 37. The coupling pipes 373o_2, 373o_4, and 373o_6 communicate with any one of the plurality of inlets (not illustrated) formed on the surface of the flow path structure 34 in the Z2 direction, and introduce the ink from the holder 37 into the flow path structure 34.

Wiring members 388 of the plurality of head chips 38 are each inserted into the six opening portions 371. The six opening portions 371 are arranged in a staggered manner.

One head chip 38 includes one nozzle plate 387 and piezoelectric elements PZq corresponding to the M nozzles N of the head chip 38. The six head chips 38 are also arranged in a staggered manner, similarly to the opening portions 351 and the notch portions 352 of the wiring substrate 35.

The head chip 38 will be described in more detail with reference to FIGS. 5 and 6.

### 1-4. Head Chip 38

FIG. 5 is an exploded perspective view of the head chip 38_1. FIG. 6 is a cross-sectional view taken along line VI-VI in FIG. 5. The line VI-VI is a virtual straight line passing through an inlet 3851 and an outlet 3852 and passing through the nozzle N. In FIG. 6, the cross section of the fixing plate 39 is also illustrated in addition to the cross section of the head chip 38_1.

The head chip 38_1 includes the nozzle plate 387, a compliance substrate 3861, a communication plate 382, a pressure chamber substrate 383, a vibration plate 384, a case 385, and the wiring member 388.

The nozzle plate 387 is a plate-shaped member that is elongated in the direction along the V axis and extends parallel to a VW plane, and the M nozzles N are formed in the nozzle plate 387. In addition, the nozzle N is a through-hole penetrating the nozzle plate 387 in the direction along the Z axis. In the present embodiment, as an example, it is assumed that the M nozzles N are provided on the nozzle plate 387 to form the nozzle array Ln extending in the direction along the V axis. However, the nozzle plate 387 may include a plurality of nozzle arrays Ln in which some of the M nozzles N are arranged in the V axis direction.

The communication plate 382 is provided in the Z1 direction of the nozzle plate 387. The communication plate 382 is a plate-shaped member that is elongated in the direction along the V axis and extends substantially parallel to the VW plane, and an ink flow path is formed in the communication plate 382. Specifically, one supply liquid chamber RA1, one discharge liquid chamber RA2, one communication flow path RX1, and one communication flow path RX2 are formed in the communication plate 382. Among them, the supply liquid chamber RA1 is provided to communicate with a supply liquid chamber RB1, which will be described below, and to extend in the direction along the V axis. The communication flow path RX1 is provided to communicate with the supply liquid chamber RA1, to be located in the W2 direction when viewed from the supply liquid chamber RA1, and to extend in the direction along the W axis. Further, the discharge liquid chamber RA2 is provided to communicate with a discharge liquid chamber RB2, which will be described below, and to extend in the direction along the V axis. Further, the communication flow path RX2 is provided to communicate with the discharge liquid chamber RA2, to be located in the W1 direction when viewed from the discharge liquid chamber RA2, and to extend in the direction along the W axis. Hereinafter, a common liquid chamber formed by the supply liquid chamber RA1, the supply liquid chamber RB1, and the communication flow path RX1 is referred to as a “supply-side common liquid chamber MN1”. Similarly, a common liquid chamber formed by the discharge liquid chamber RA2, the discharge liquid chamber RB2, and the communication flow path RX2 is referred to as a “discharge-side common liquid chamber MN2”.

In addition, in the communication plate 382, M nozzle flow paths RN corresponding one-to-one to the M nozzles N, M communication flow paths RR1 corresponding one-to-one to the M nozzles N, M communication flow paths RR2 corresponding one-to-one to the M nozzles N, M communication flow paths RK1 corresponding one-to-one to the M nozzles N, and M communication flow paths RK2 corresponding one-to-one to the M nozzles N are formed.

In the first embodiment, the communication flow path RK1 is provided to communicate with the communication flow path RX1, to be located in the W2 direction when viewed from the communication flow path RX1, and to extend in the Z axis direction. Further, the communication flow path RR1 is provided to be located in the W2 direction when viewed from the communication flow path RK1, and to extend in the Z axis direction. Further, the communication flow path RK2 is provided to communicate with the communication flow path RX2, to be located in the W1 direction when viewed from the communication flow path RX2, and to extend in the Z axis direction. Further, the communication flow path RR2 is provided to be located in the W1 direction when viewed from the communication flow path RK2, to be located in the W2 direction when viewed from the communication flow path RR1, and to extend in the Z axis direction.

Further, the nozzle flow path RN is provided to communicate with the communication flow path RR1 and the communication flow path RR2, to be located in the W2 direction when viewed from the communication flow path RR1, to be located in the W1 direction when viewed from the communication flow path RR2, and to extend in the W axis direction. The nozzle flow path RN communicates with the nozzle N corresponding to the nozzle flow path RN.

The pressure chamber substrate 383 is provided in the Z1 direction of the communication plate 382. The pressure chamber substrate 383 is a plate-shaped member that is elongated in the direction along the V axis and extends substantially parallel to the VW plane, and an ink flow path is formed in the pressure chamber substrate 383. Specifically, in the pressure chamber substrate 383, M pressure chambers CB1 corresponding one-to-one to the M nozzles N and M pressure chambers CB2 corresponding one-to-one to the M nozzles N are formed. Hereinafter, the pressure chamber CB1 and the pressure chamber CB2 are collectively referred to as a pressure chamber CB. The pressure chamber CB1 is provided to communicate with the communication flow path RK1 and the communication flow path RR1, to couple an end portion of the communication flow path RK1 in the W1 direction and an end portion of the communication flow path RR1 in the W2 direction when viewed in the direction along the Z axis, and to extend in the direction along the W axis. In addition, the pressure chamber CB2 is provided to communicate with the communication flow path RK2 and the communication flow path RR2, to connect an end portion of the communication flow path RK2 in the W2 direction and an end portion of the communication flow path RR2 in the W1 direction when viewed in the direction along the Z axis, and to extend in the direction along the W axis. The number of the pressure chambers CB provided corresponding to one nozzle N may be one, in other words, any one of the pressure chamber CB1 and the pressure chamber CB2 may be provided for one nozzle N.

The vibration plate 384 is provided in the Z1 direction of the pressure chamber substrate 383. The vibration plate 384 is a plate-shaped member that is elongated in the direction along the V axis and extends substantially parallel to the VW plane, and is a member that can vibrate elastically. The vibration plate 384 may be formed of the same member as the pressure chamber substrate 383.

M piezoelectric elements PZ1 corresponding one-to-one to the M pressure chambers CB1 and M piezoelectric elements PZ2 corresponding one-to-one to the M pressure chambers CB2 are provided on a surface of the vibration plate 384 in the Z1 direction. Hereinafter, the piezoelectric element PZ1 and the piezoelectric element PZ2 are collectively referred to as the piezoelectric element PZq.

The piezoelectric element PZq is a passive element deformed in accordance with a change in potential of the drive signal Com.

The fixing plate 39 adheres to a surface of the compliance substrate 3861 in the Z2 direction and a surface of the holder 37 in the Z2 direction. That is, six exposure opening portions 391 provided in the fixing plate 39 expose a nozzle surface SN of the nozzle plate 387 within the exposure opening portions 391. The nozzle surface SN is a surface on which the plurality of nozzles N are formed and that faces the Z2 direction of the nozzle plate 387, and is a surface perpendicular to the Z2 direction. The ejection surface FN illustrated in FIG. 3 is partitioned into the nozzle surface SN and a surface 39N of the fixing plate 39 facing the Z2 direction. The six exposure opening portions 391 are also arranged in a staggered manner, similarly to the opening portions 351 and the notch portions 352 of the wiring substrate 35.

The compliance substrate 3861 includes a flexible film 3861a and a support plate 3861b.

The flexible film 3861a is a flexible member such as a film, and the support plate 3861b is a rigid member. The flexible film 3861a is a member that is fixed to a surface of the communication plate 382 in the Z2 direction and covers the openings that define the supply liquid chamber RA1, the communication flow path RX1, the communication flow path RK1, the communication flow path RK2, the communication flow path RX2, and the discharge liquid chamber RA2 of the communication plate 382 from the Z2 direction side, and defines these elements. The support plate 3861b is fixed to a surface of the flexible film 3861a in the Z2 direction, and an opening is formed at a position overlapping the supply liquid chamber RA1, the communication flow path RX1, the communication flow path RK1, the communication flow path RK2, the communication flow path RX2, and the discharge liquid chamber RA2 when viewed in the direction along the Z axis. The fixing plate 39 adheres to the support plate 3861b to seal the opening of the support plate 3861b in the Z2 direction. A space defined by the surface of the flexible film 3861a in the Z2 direction, the opening of the support plate 3861b, and the surface of the fixing plate 39 in the Z1 direction communicates with the atmosphere by an atmospheric communication path (not illustrated), and the flexible film 3861a can absorb the pressure fluctuations generated in the head chips 38 by being deformed in the Z1 direction and the Z2 direction by the space.

The case 385 is provided in the Z1 direction of the communication plate 382. The case 385 is a member that is elongated in the direction along the V axis, and an ink flow path is formed in the case 385. Specifically, one supply liquid chamber RB1 and one discharge liquid chamber RB2 are formed in the case 385. Among them, the supply liquid chamber RB1 is provided to communicate with the supply liquid chamber RA1, to be located in the Z1 direction when viewed from the supply liquid chamber RA1, and to extend in the direction along the V axis. Further, the discharge liquid chamber RB2 is provided to communicate with the discharge liquid chamber RA2, to be located in the Z1 direction when viewed from the discharge liquid chamber RA2 and in the W2 direction when viewed from the supply liquid chamber RB1, and to extend in the direction along the V axis.

In addition, the inlet 3851 that communicates with the supply liquid chamber RB1 and the outlet 3852 that communicates with the discharge liquid chamber RB2 are provided in the case 385. In the supply liquid chamber RB1, the ink is supplied from the liquid container 93 to the supply-side common liquid chamber MN1 through the inlet 3851. The ink supplied to the supply-side common liquid chamber MN1 is stored in the discharge-side common liquid chamber MN2 through the flow path that communicates with the nozzles N. The ink stored in the discharge-side common liquid chamber MN2 is collected through the outlet 3852.

Further, an opening 3850 is provided in the case 385. The pressure chamber substrate 383, the vibration plate 384, and the wiring member 388 are provided inside the opening 3850. The case 385 is formed by, for example, injection molding of a resin material. However, any known material or manufacturing method can be used for manufacturing the case 385.

The description will return to FIG. 4. Although the head chip 38_1 is described with reference to FIGS. 5 and 6, the configurations of the head chips 38_2 to 38_6 are also the same as the configuration of the head chip 38_1. The wiring members 388 of the head chips 38_1 to 38_6 have the same shape. The wiring members 388 of the head chips 38_2, 38_4, and 38_6 are disposed in an orientation obtained by rotating by 180 degrees about the Z axis with respect to an orientation of the wiring member 388 of the head chip 38_1.

### 1-5. Variation in Landing Position

As can be understood from FIG. 3 and the like, by arranging the plurality of nozzles N along the V axis inclined with respect to the direction along the Y axis, the resolution in the direction along the X axis can be increased as compared with an aspect in which the plurality of nozzles N are arranged linearly along the direction along the X axis. Hereinafter, the V1 direction that is the direction along the nozzle array Ln may be referred to as a “nozzle array direction”.

However, when the nozzle array direction is inclined with respect to the transport direction of the medium PP, that is, the Y1 direction in the present embodiment, there is a concern that a variation occurs in a position at which the ink lands on the medium PP.

The present inventor found that, in the aspect in which the plurality of nozzles N are arranged linearly along the direction along the X axis, the jet flow generated by the ink ejection from the nozzle N is eliminated or reduced by the airflow generated by the transport of the medium PP in the Y1 direction, so that the variation in the landing position due to the jet flow generated by the ink ejection is suppressed. Hereinafter, the airflow generated by the transport of the medium PP is referred to as a “transport airflow”, and the jet flow generated by the ink ejection is referred to as a “self-jet flow”. In addition, the density unevenness due to the variation in the landing position caused by the generation of the vortex flow in the vicinity of the nozzle N by the self-jet flow may be referred to as “wind ripples”. When the nozzle array direction is inclined with respect to the transport direction of the medium PP, the plurality of nozzles N include the nozzle N located upstream of the transport direction and the nozzle N located downstream of the transport direction. The nozzle N located upstream of the transport direction may be referred to as an “upstream nozzle Nu”, and the nozzle N located downstream of the transport direction may be referred to as a “downstream nozzle Nd”.

When the nozzle array direction is inclined with respect to the transport direction, the occurrence of the wind ripples is suppressed in the upstream nozzle Nu by the transport airflow. However, the present inventor found that, as a result of the collision between the transport airflow and the self-jet flow of the upstream nozzle Nu, the transport airflow is eliminated or reduced, and the variation in the landing position due to the self-jet flow of the downstream nozzle Nd located downstream of the upstream nozzle Nu cannot be suppressed, and thus the wind ripples occur. Therefore, there is a concern that the uneven printing occurs between the upstream nozzle Nu and the downstream nozzle Nd.

Therefore, in the present embodiment, the liquid ejecting apparatus 100 includes the air blowing mechanism 96, and the air blowing mechanism 96 uniformly applies the airflow to each nozzle N of the nozzle array Ln to suppress the variation in the landing position. The air blowing mechanism 96 will be described with reference to FIG. 7.

### 1-6. Air Blowing Mechanism 96

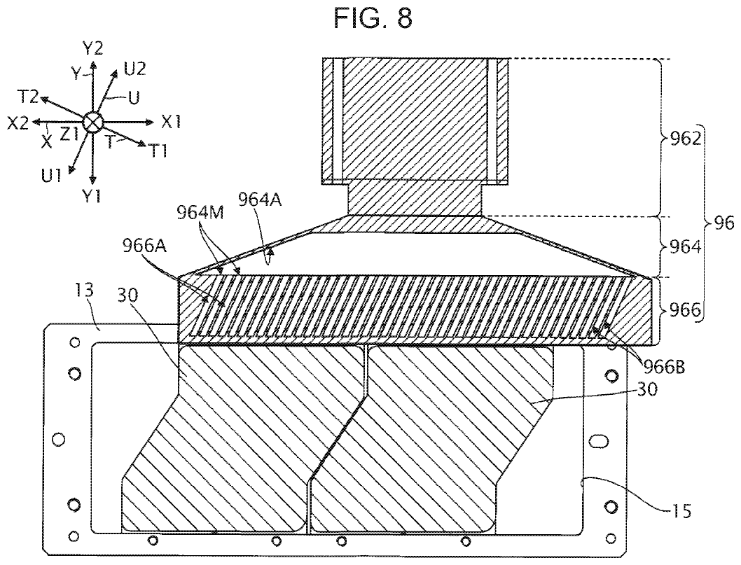

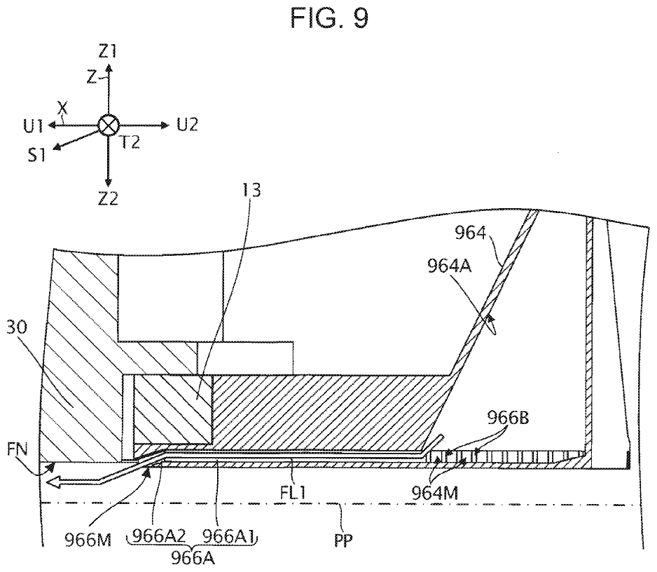

FIG. 7 is a view of the head module 3 when viewed in the X1 direction. However, in FIG. 7, a part of the liquid ejecting head 30 is not illustrated. FIG. 8 is a cross-sectional view taken along line VIII-VIII in FIG. 7. FIG. 9 is a cross-sectional view taken along line IX-IX in FIG. 2. As illustrated in FIGS. 7 and 8, the air blowing mechanism 96 includes a fan housing section 962, an aggregation section 964, and a rectifying section 966. The line VIII-VIII is a virtual straight line parallel to the XY plane and passing through the rectifying section 966. The line IX-IX is a virtual straight line extending in a U1 direction that is a direction in which the air blowing mechanism 96 blows the air in plan view when viewed in the direction along the Z axis. A direction opposite to the U1 direction is referred to as a U2 direction. The U1 direction and the U2 direction may be collectively referred to as a direction along a U axis. Further, a direction perpendicular to the Z axis and perpendicular to the U axis is referred to as a T1 direction and a T2 direction. The T1 direction is the direction between the X1 direction and the Y1 direction, and the T2 direction is the direction between the X2 direction and the Y2 direction. The T1 direction and the T2 direction may be collectively referred to as a direction along a T axis. In FIGS. 8 and 9, in order to prevent the drawings from being complicated, an internal structure of the liquid ejecting head 30 is not illustrated. In addition, in FIG. 9, in order to prevent the drawing from being complicated, the periphery of the aggregation section 964 and the rectifying section 966 is enlarged and illustrated, and the other portions are not illustrated.

As can be understood from FIG. 7, in the Z axis, an end of the rectifying section 966 in the Z2 direction is located in the Z2 direction with respect to an end of the liquid ejecting head 30 in the Z2 direction.

The fan housing section 962 is a housing having a substantially rectangular parallelepiped shape extending along the X axis. The fan housing section 962 has a space 962A that houses a plurality of fans 962F. In addition, an opening 962K for taking in air into the space 962A is provided on a side wall of the fan housing section 962 facing the Y2 direction. The opening 962K may be one or may be divided into two or more openings. The space 962A and the outside of the air blowing mechanism 96 communicate with each other through the opening 962K. Further, an opening 962M for blowing the air into the aggregation section 964 is provided in the Y1 direction of the fan housing section 962. The plurality of fans 962F are disposed along the X axis. The plurality of fans 962F take in the air from the opening 962K and blow the air to the opening 962M.

The aggregation section 964 aggregates the air blown by the fan 962F. The aggregation section 964 is a hollow member having a trapezoidal shape. A size of a surface of the aggregation section 964 facing the Y1 direction is larger than a size of a surface of the aggregation section 964 facing the Y2 direction. A length of the surface of the aggregation section 964 facing the Y1 direction in the Z axis is shorter than a length of the surface of the aggregation section 964 facing the Y2 direction in the Z axis. On the other hand, a length of the surface of the aggregation section 964 facing the Y2 direction in the X axis is shorter than a length of the surface of the aggregation section 964 facing the Y1 direction in the Z axis. The aggregation section 964 has a space 964A inside. An opening 964K is provided on the surface of the aggregation section 964 facing the Y2 direction. The space 964A and the space 962A communicate with each other through the opening 964K and the opening 962M. Further, a plurality of openings 964M are provided in the Y1 direction of the aggregation section 964.

The rectifying section 966 rectifies, in the U1 direction, the blowing direction of the air aggregated by the aggregation section 964. The rectifying section 966 includes a plurality of through-holes 966A that penetrate along the U axis in plan view, and a plurality of partition walls 966B that extend in the direction along the U axis. A space between two adjacent through-holes 966A is separated by the partition wall 966B. Specifically, the through-hole 966A includes a first space 966A1 along the U axis, and a second space 966A2 that communicates with the first space 966A1 and extends in an S1 direction. The S1 direction is a direction inclined in the Z2 direction with respect to the U1 direction. The first space 966A1 communicates with the aggregation section 964 through the opening 964M at an end portion in the U2 direction. The second space 966A2 communicates with the outside of the air blowing mechanism 96 through an opening 966M provided at an end portion in the S1 direction. FIG. 9 illustrates a flow FL1 of the airflow passing through the through-hole 966A. As indicated by the flow FL1, the air aggregated by the aggregation section 964 is suctioned into the through-hole 966A through the opening 964M. The air discharged from the opening 966M moves in the U1 direction along the ejection surface FN as indicated by the flow FL1. That is, the flow FL1 of the airflow in the direction along the Z axis is along the U1 direction. Therefore, the air blowing mechanism 96 generates the flow FL1 of the airflow in the U1 direction when viewed in the direction along the Z axis.

### 1-7. Blowing Direction of Air Blowing Mechanism 96

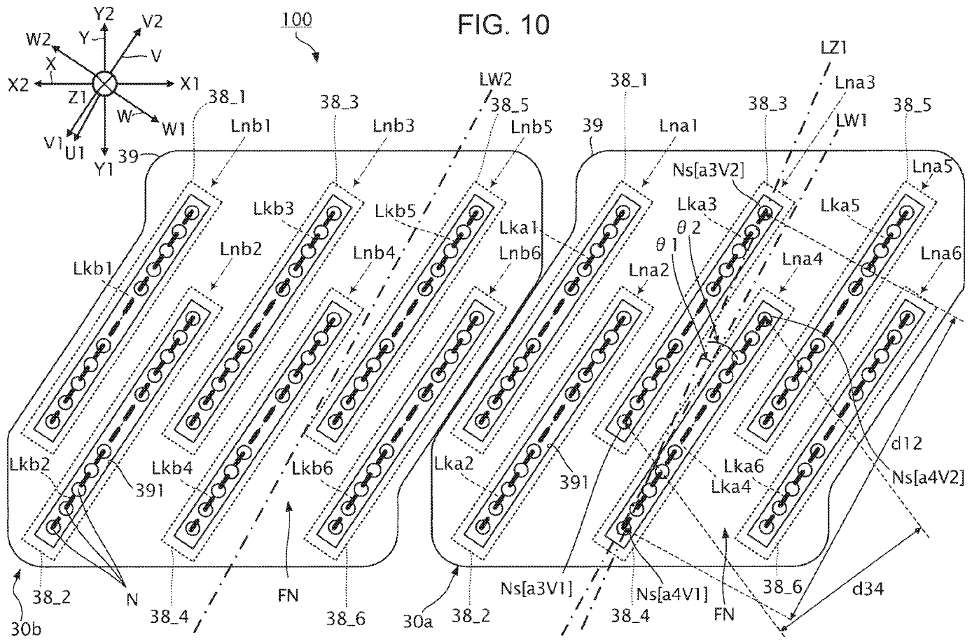

FIG. 10 is a diagram illustrating the blowing direction of the air blowing mechanism 96. In FIG. 10, among the two liquid ejecting heads 30, the liquid ejecting head 30 provided in the X1 direction is illustrated as a liquid ejecting head 30a, and the liquid ejecting head 30 provided in the X2 direction is illustrated as a liquid ejecting head 30 b. Further, hereinafter, for any variable i from 1 to 6, the nozzle array Ln including the M nozzles N included in the head chip 38_i of the liquid ejecting head 30a may be referred to as a nozzle array Lnai. Similarly, for any variable i from 1 to 6, the nozzle array Ln including the M nozzles N included in the head chip 38_i of the liquid ejecting head 30b may be referred to as a nozzle array LnBi.

FIG. 10 illustrates the U1 direction that is the blowing direction of the air blowing mechanism 96. As illustrated in FIG. 10, the U1 direction intersects all of the Y1 direction, the direction along the X axis, and the direction along the V axis. The Y1 direction is an example of a “first direction in which the medium is transported”, the direction along the X axis is an example of a “second direction orthogonal to both the first direction and the ejection direction”, and the U1 direction is an example of a “third direction”.

In the first embodiment, all of the plurality of nozzles N included in the two liquid ejecting heads 30 are used for the printing operation. In the present specification, the nozzle N that is used for the printing operation means the nozzle N that ejects the ink for directly forming a part of the image to the medium PP when forming the image on the medium PP. On the other hand, the nozzle N that is not used for the printing operation means the nozzle N that does not eject the ink for directly forming a part of the image to the medium PP when forming the image on the medium PP. That is, the ink ejected by a flushing operation of ejecting the ink to the medium PP for the purpose of discharging the ink thickened during the printing operation is not the ink for directly forming a part of the image, and thus the nozzle N that ejects the ink to the medium PP only in the flushing operation is the nozzle N that is not used for the printing operation. Hereinafter, the nozzle N that is used for the printing operation may be referred to as a “used nozzle Ns”, and the nozzle N that is not used for the printing operation may be referred to as an “unused nozzle Ni”. As described above, in the first embodiment, all of the plurality of nozzles N included in the liquid ejecting apparatus 100 are the used nozzles Ns.

In the example of FIG. 10, a nozzle line segment Lk coupling the used nozzle Ns disposed at an end in the V1 direction that is the nozzle array direction and the used nozzle Ns disposed at an end in the V2 direction that is a direction opposite to the V1 direction is illustrated for all of the nozzle arrays Ln included in the two liquid ejecting heads 30. Hereinafter, for a certain nozzle array Ln, the nozzle line segment Lk coupling the used nozzle Ns disposed at the end in the V1 direction and the used nozzle Ns disposed at the end in the V2 direction may be referred to as the nozzle line segment Lk corresponding to the nozzle array Ln. In the example of FIG. 10, for any variable i from 1 to 6, the nozzle line segment Lk corresponding to the nozzle array Ln included in the head chip 38_i of the liquid ejecting head 30a is referred to as a nozzle line segment Lkai. Further, for any variable i from 1 to 6, the nozzle line segment Lk corresponding to the nozzle array Ln included in the head chip 38_i of the liquid ejecting head 30b is referred to as a nozzle line segment Lkbi. Hereinafter, the nozzle line segment Lkai and the nozzle line segment Lkbi may be collectively referred to as the nozzle line segment Lk without distinction. In FIG. 10, since 12 nozzle arrays Ln are illustrated, 12 nozzle line segments Lk are illustrated.

In FIG. 10, virtual straight lines LW1 and LW2 projected on the ejection surface FN are illustrated. Hereinafter, these virtual straight lines LW1 and LW2 may be collectively referred to as a virtual straight line LW without distinction. The virtual straight line LW is a straight line that extends in the U1 direction. That is, the airflow generated by the air blowing mechanism 96 flows in the U1 direction along the virtual straight line LW at a position facing the ejection surface FN. The virtual straight line LW may be projected on the ejection surface FN at any position in the direction along the X axis, but in FIG. 10, in order to prevent the drawing from being complicated, only the virtual straight lines LW1 and LW2 are illustrated.

As can be understood from FIG. 10, the number of the nozzle line segments Lk overlapping the virtual straight line LW is 1 or less regardless of the position of the virtual straight line LW in the direction along the X axis. In plan view, the virtual straight line LW1 passes through the center of the nozzle N disposed at the end in the V1 direction in the nozzle array Lna4. Therefore, the number of the nozzle line segments Lk overlapping the virtual straight line LW1 is one, that is, the nozzle line segment Lka4. In plan view, the virtual straight line LW2 passes between the nozzle line segment Lkb4 and the nozzle line segment Lkb5. Therefore, the number of the nozzle line segments Lk overlapping the virtual straight line LW2 is zero. Hereinafter, the used nozzle Ns disposed at the end in the V1 direction in the nozzle array Lna4 may be referred to as a used nozzle Ns[a4V1]. The nozzle array Lna4 is an example of a “first nozzle array”, and the used nozzle Ns[a4V1] is an example of a “first used nozzle”.

In addition, in FIG. 10, a first straight line LZ1 is illustrated. The first straight line LZ1 passes through the used nozzle Ns[a4V1] and the used nozzle Ns disposed at the end in the V2 direction in the nozzle array Lna3. Hereinafter, the used nozzle Ns disposed at the end in the V2 direction in the nozzle array Lna3 may be referred to as a used nozzle Ns[a3V2]. The nozzle array Lna3 is an example of a “second nozzle array”, and the used nozzle Ns[a3V2] is an example of a “second used nozzle”.

In addition, a first angle θ1 formed between the virtual straight line LW1 and the first straight line LZ1 is equal to or less than half of a second angle θ2 formed between the first straight line LZ1 and the nozzle line segment Lka4 corresponding to the nozzle array Lna4.

The smaller the first angle θ1, the more preferable it is, and for example, it is preferable that the first angle θ1 is less than half of the second angle θ2. The first angle θ1 and the second angle θ2 are acute angles.

In addition, the first straight line LZ1 overlaps the nozzle line segment Lka4 and the nozzle line segment Lka3, and does not overlap the other nozzle line segments Lk other than the nozzle line segment Lka4 and the nozzle line segment Lka3.

In addition, a distance d12 between the used nozzle Ns[a4V1] and the used nozzle Ns[a3V2], which are the used nozzles Ns, is longer than a distance d34 between the used nozzle Ns[a4V2], which is the used nozzle Ns disposed at the end in the V2 direction in the nozzle array Lna4, and the used nozzle Ns[a3V1], which is the used nozzle Ns disposed at the end in the V1 direction in the nozzle array Lna3. The used nozzle Ns[a4V2] is an example of a “third used nozzle”, and the used nozzle Ns[a3V1] is an example of a “fourth used nozzle”.

Among the combinations of two nozzle line segments Lk selected from the 12 nozzle line segments Lk, a pair of two nozzle line segments Lk having the greatest overlapping amount when viewed in the Y1 direction are two nozzle line segments Lk adjacent along the Y axis. Specifically, the pairs of two nozzle line segments Lk having the greatest overlapping amount are a pair of the nozzle line segment Lka1 and the nozzle line segment Lka2, a pair of the nozzle line segment Lka3 and the nozzle line segment Lka4, a pair of the nozzle line segment Lka5 and the nozzle line segment Lka6, a pair of the nozzle line segment Lkb1 and the nozzle line segment Lkb2, a pair of the nozzle line segment Lkb3 and the nozzle line segment Lkb4, and a pair of the nozzle line segment Lkb5 and the nozzle line segment Lkb6.

### 1-8. Summary of First Embodiment

Hereinafter, the summary of the first embodiment will be described by defining the “first nozzle array” as the nozzle array Lna4 and the “second nozzle array” as the nozzle array Lna3.

In the liquid ejecting apparatus 100 according to the first embodiment, the liquid ejecting head 30 includes the ejection surface FN including the plurality of nozzle arrays Ln in which the plurality of nozzles N that eject the ink in the Z2 direction that is the ejection direction are arranged in the V1 direction that is the nozzle array direction, the transport mechanism 92 that transports the medium PP in the Y1 direction at the position facing the ejection surface FN, and the air blowing mechanism 96. The nozzle array direction intersects both the Y1 direction and a direction along the X axis orthogonal to both the Y1 direction and the Z2 direction. The air blowing mechanism 96 generates the airflow along the ejection surface FN in the U1 direction intersecting all of the Y1 direction, the direction along the X axis, and the V1 direction.

According to the first embodiment, even when the nozzle array direction that is the V1 direction is inclined with respect to the transport direction that is the Y1 direction of the medium PP, the airflow by the air blowing mechanism 96 can easily reach the nozzle N that is difficult for the transport airflow to reach in the aspect of not including the air blowing mechanism 96, and the self-jet flow can be suppressed, so that the variation in the landing position due to the self-jet flow can be suppressed.

In addition, the plurality of nozzles N include the plurality of used nozzles Ns that are used for the printing operation of ejecting the ink toward the medium PP, and when the line segment coupling the used nozzle Ns disposed at the end in the V1 direction that is the nozzle array direction and the used nozzle Ns disposed at the end in the V2 direction that is a direction opposite to the V1 direction in each of the plurality of nozzle arrays Ln is defined as the nozzle line segment Lk, the number of the nozzle line segments Lk overlapping the virtual straight line LW1 projected on the ejection surface FN and extending in the U1 direction among the plurality of nozzle line segments Lk corresponding to the plurality of nozzle arrays Ln is 1 or less.

When the number of the nozzle line segments Lk overlapping the virtual straight line LW1 is 2 or more, among the two or more nozzle line segments Lk overlapping the virtual straight line LW1, there are the nozzle line segment Lk located in the Y2 direction and the nozzle line segment Lk other than the nozzle line segment Lk located in the Y2 direction. Then, since the airflow generated by the air blowing mechanism 96 is eliminated or reduced by the self-jet flow of the nozzle N corresponding to the nozzle line segment Lk located in the Y2 direction, there is a concern that the self-jet flow of the nozzle N corresponding to the nozzle line segment other than the nozzle line segment Lk located in the Y2 direction cannot be suppressed. Therefore, according to the first embodiment, since the airflow generated by the air blowing mechanism 96 hits a larger number of the used nozzles Ns as compared with the aspect in which the number of the nozzle line segments Lk overlapping the virtual straight line LW1 is 2 or more, the variation in the landing position due to the self-jet flow can be suppressed in a larger number of the used nozzles Ns.

In addition, the plurality of nozzle arrays Ln include the nozzle array Lna4 and the nozzle array Lna3 that are adjacent to each other, and the first angle θ1 formed between the virtual straight line LW1 and the first straight line LZ1 is equal to or less than half of the second angle θ2 formed between the first straight line LZ1 and the nozzle line segment Lka4 corresponding to the nozzle array Lna4.

When the first angle θ1 becomes large and, for example, the virtual straight line LW1 and the nozzle line segment Lk become substantially parallel to each other, the airflow generated by the air blowing mechanism 96 is likely to be eliminated or reduced by the self-jet flow of the nozzle N located in the Y2 direction among the M used nozzles Ns corresponding to the nozzle line segment Lk, and there is a concern that it is difficult to suppress the self-jet flow of the used nozzle Ns located in the Y1 direction with respect to the nozzle N. According to the first embodiment, the airflow generated by the air blowing mechanism 96 can be uniformly applied to each used nozzle Ns of the nozzle array Ln as compared with the aspect in which the first angle θ1 is equal to or greater than half of the second angle θ2.

In addition, each of the nozzle array Lna4 and the nozzle array Lna3 is one of two nozzle arrays Ln having the narrowest interval in the direction along the W axis orthogonal to the V1 direction among the plurality of nozzle arrays Ln.

Among the two nozzle arrays Ln having the narrowest interval in the direction along the W axis among the plurality of nozzle arrays Ln, the nozzle array Ln located in the Y2 direction is least likely to be hit by the transport airflow. Therefore, according to the first embodiment, the airflow generated by the air blowing mechanism 96 can be applied to the nozzle array Ln that is least likely to be hit by the transport airflow.

In addition, the liquid ejecting head 30 constitutes the line head of which the longitudinal direction is the direction along the X axis, the plurality of nozzle arrays Ln are arranged in the direction along the X axis, and the two adjacent nozzle arrays Ln among the plurality of nozzle arrays Ln at least partially overlap each other when viewed in the Y1 direction that is the transport direction.

When the two adjacent nozzle arrays Ln at least partially overlap each other when viewed in the Y1 direction, the nozzle N that is hit by the transport airflow and the nozzle N that is difficult to be hit by the transport airflow are generated. Therefore, according to the first embodiment, the variation in the landing position due to the self-jet flow can be suppressed by the airflow generated by the air blowing mechanism 96 even for the nozzle N that is difficult to be hit by the transport airflow.

### 2. Second Embodiment

The head chip 38 according to the first embodiment includes one nozzle array Ln, but the present disclosure is not limited to this. Hereinafter, a second embodiment will be described.

### 2-1. Blowing Direction in Second Embodiment

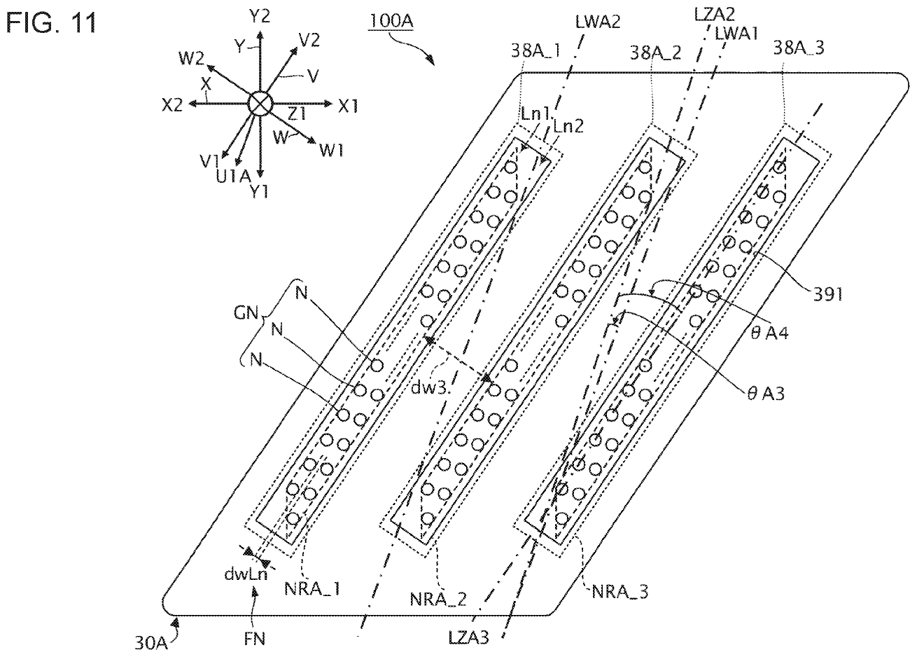

FIG. 11 is a diagram illustrating the blowing direction of the air blowing mechanism 96 in the second embodiment.

A liquid ejecting apparatus 100A according to the second embodiment is different from the liquid ejecting apparatus 100 in that a liquid ejecting head 30A is included instead of the liquid ejecting head 30. The liquid ejecting head 30A is different from the liquid ejecting head 30 in that three head chips 38A are included instead of the six head chips 38. The three head chips 38A are an example of a “plurality of head chips”. In the second embodiment, the liquid ejecting head 30A includes the three head chips 38A, but need only include two or more head chips 38A.

The three head chips 38A are different from the head chips 38 in that each of the three head chips 38A includes a nozzle group GN including 2M nozzles N that are divided into a nozzle array Ln1 and a nozzle array Ln2 that are arranged at an interval in the direction along the W axis. Hereinafter, the nozzle array Ln1 and the nozzle array Ln2 may be collectively referred to as the nozzle array Ln without distinction. In order to prevent the drawing from being complicated, reference numerals are given only to some of the nozzles N included in the nozzle group GN.

The liquid ejecting head 30A includes the three head chips 38A, that is, a head chip 38A_1, a head chip 38A_2, and a head chip 38A_3. Hereinafter, these head chips 38A_1, 38A_2, and 38A_3 will be described as the head chip 38A when there is no need of distinction. The three head chips 38A are disposed along the X axis.

As illustrated in FIG. 11, in the second embodiment, the ejection surface FN that is a surface of one liquid ejecting head 30 facing the Z2 direction includes six nozzle arrays Ln.

As in the first embodiment, in the second embodiment, all of the plurality of nozzles N included in the liquid ejecting apparatus 100A are the used nozzles Ns.

FIG. 11 illustrates a smallest convex polygon surrounding all of the used nozzles Ns included in the nozzle group GN included in one head chip 38A. In FIG. 11, the convex polygon is a parallelogram. Hereinafter, the region surrounded by the convex polygon may be referred to as a nozzle region NRA. Furthermore, for ease of understanding, for any variable i from 1 to 3, the nozzle region NRA surrounded by the smallest convex polygon surrounding the 2M used nozzles Ns included in the nozzle group GN included in the head chip 38A_i may be referred to as a nozzle region NRA_i. Hereinafter, the nozzle regions NRA_1 to NRA_3 may be collectively referred to as the nozzle region NRA without distinction. The nozzle region NRA is elongated in the V1 direction. The V1 direction is an example of a “fourth direction”.

An interval dw3 between the two adjacent nozzle regions NRA in the W axis in one liquid ejecting head 30A is substantially the same for all cases. The interval dw3 is sufficiently wider than an interval dwLn between the two nozzle arrays Ln included in one head chip 38A.

As illustrated in FIG. 11, the three nozzle regions NRA are arranged in the direction along the X axis. As illustrated in FIG. 11, in the three nozzle regions NRA, two adjacent nozzle regions NRA at least partially overlap each other when viewed in the Y1 direction. For example, when viewed in the Y1 direction, a part of the nozzle region NRA_1 and a part of the nozzle region NRA_2 overlap each other.

In the second embodiment, the air blowing mechanism 96 generates the airflow along the ejection surface FN in the U1A direction intersecting all of the Y1 direction, the direction along the X axis, and the V1 direction. In the second embodiment, the U1A direction is an example of a “third direction”.

In FIG. 11, virtual straight lines LWA1 and LWA2 projected on the ejection surface FN are illustrated. Hereinafter, the virtual straight lines LWA1 and LWA2 may be collectively referred to as a virtual straight line LWA without distinction. The virtual straight line LWA is a straight line that extends in the U1A direction. That is, the airflow generated by the air blowing mechanism 96 flows in the U1A direction along the virtual straight line LWA at a position facing the ejection surface FN. The virtual straight line LWA may be projected on the ejection surface FN at any position in the direction along the X axis, but in FIG. 11, in order to prevent the drawing from being complicated, only the virtual straight lines LWA1 and LWA2 are illustrated.

As can be understood from FIG. 11, the number of the nozzle regions NRA overlapping the virtual straight line LWA among the three nozzle regions NRA is 1 or less regardless of the position of the virtual straight line LWA in the direction along the X axis. Specifically, the virtual straight line LWA1 passes through the center of the nozzle N disposed at the end portion of the nozzle region NRA_3 in the V1 direction in plan view. Therefore, the number of the nozzle regions NRA overlapping the virtual straight line LWA1 is one, that is, the nozzle region NRA_3. The virtual straight line LWA2 passes between the nozzle region NRA_1 and the nozzle region NRA_2 in plan view. Therefore, the number of the nozzle regions NRA overlapping the virtual straight line LWA2 is zero.

In addition, in FIG. 11, a second straight line LZA2 and a third straight line LZA3 are illustrated. The second straight line LZA2 is a straight line that is externally tangent to the end portion of the nozzle region NRA_3 in the V1 direction and the end portion of the nozzle region NRA_2 in the V2 direction. The third straight line LZA3 is a straight line that extends in the V1 direction. A third angle θA3 formed between the virtual straight line LWA1 and the second straight line LZA2 is equal to or less than half of a fourth angle θA4 formed between the second straight line LZA2 and the third straight line LZA3. The smaller the third angle θA3, the more preferable it is, and for example, it is preferable that the third angle θA3 is less than half of the fourth angle θA4.

In addition, the second straight line LZA2 is externally tangent to the nozzle region NRA_2 and the nozzle region NRA_3, and is not tangent to or does not overlap the other nozzle regions NRA other than the nozzle region NRA_2 and the nozzle region NRA_3.

### 2-2. Summary of Second Embodiment

Hereinafter, the summary of the second embodiment will be described by defining the “first nozzle group” as the nozzle group GN included in the head chip 38A_3, the “second nozzle group” as the nozzle group GN included in the head chip 38A_2, the “nozzle region corresponding to the first nozzle group” as the nozzle region NRA_3, and the “nozzle region corresponding to the second nozzle group” as the nozzle region NRA_2. Hereinafter, for simplification of the description, the nozzle group GN included in the head chip 38A_3 may be referred to as a nozzle group GNA_3, and the nozzle group GN included in the head chip 38A_2 may be referred to as a nozzle group GNA_2.

The liquid ejecting apparatus 100A includes the liquid ejecting head 30A including the plurality of head chips 38A each including the nozzle group GN including the plurality of nozzles N that eject the ink in the Z2 direction that is the ejection direction, the transport mechanism 92 that transports the medium PP in the Y1 direction at a position facing the ejection surface FN of the liquid ejecting head 30A, and the air blowing mechanism 96. The plurality of nozzles N include the plurality of used nozzles Ns that are used for the printing operation of ejecting the ink toward the medium PP. When the region surrounded by the smallest convex polygon surrounding the plurality of used nozzles Ns in each of the plurality of nozzle groups GN is defined as the nozzle region NRA, the nozzle region NRA is elongated in the V1 direction intersecting both the Y1 direction and the direction along the X axis orthogonal to both the Y1 direction and the Z2 direction. The air blowing mechanism 96 generates the airflow along the ejection surface FN in the U1A direction intersecting all of the Y1 direction, the direction along the X axis, and the V1 direction.

According to the second embodiment, as in the first embodiment, the airflow by the air blowing mechanism 96 can reach the nozzle N that is difficult for the transport airflow to reach in the aspect of not including the air blowing mechanism 96, and the self-jet flow can be suppressed, so that the variation in the landing position due to the self-jet flow can be suppressed.

In addition, the number of the nozzle regions NRA overlapping the virtual straight line LWA1 projected on the ejection surface FN and extending in the U1A direction among the nozzle regions NRA corresponding to the plurality of nozzle groups GN is 1 or less.

According to the second embodiment, as in the first embodiment, since the airflow generated by the air blowing mechanism 96 hits a larger number of the used nozzles Ns as compared with the aspect in which the number of the nozzle regions NRA overlapping the virtual straight line LWA1 is 2 or more, the variation in the landing position due to the self-jet flow can be suppressed in a larger number of the used nozzles Ns.

In addition, the plurality of nozzle groups GN include the nozzle group GNA_3 and the nozzle group GNA_2 that are adjacent to each other, and when the straight line that is externally tangent to the end portion of the nozzle region NRA_3 corresponding to the nozzle group GNA_3 in the V1 direction and the end portion of the nozzle region NRA_2 corresponding to the nozzle group GNA_2 in the V2 direction is defined as the second straight line LZA2, the third angle θA3 formed between the virtual straight line LWA1 and the second straight line LZA2 is equal to or less than half of the fourth angle θA4 formed between the second straight line LZA2 and the third straight line LZA3 extending in the V1 direction.

According to the second embodiment, the airflow generated by the air blowing mechanism 96 can be uniformly applied to each used nozzle Ns of the nozzle group GN as compared with the aspect in which the third angle θA3 is equal to or greater than half of the fourth angle θA4.

### 3. Modification Examples

The above aspects can be variously modified. Specific modification aspects that can be applied to each of the above embodiments will be described below. Any two or more aspects selected from the following examples can be combined as appropriate as long as there is no contradiction.

### 3-1. First Modification Example

In the first embodiment, all of the plurality of nozzles N included in the liquid ejecting head 30 are the used nozzles Ns, but the present disclosure is not limited to this, and the unused nozzles Ni may be included. Hereinafter, a first modification example will be described.

### 3-1-1. Blowing Direction in First Modification Example

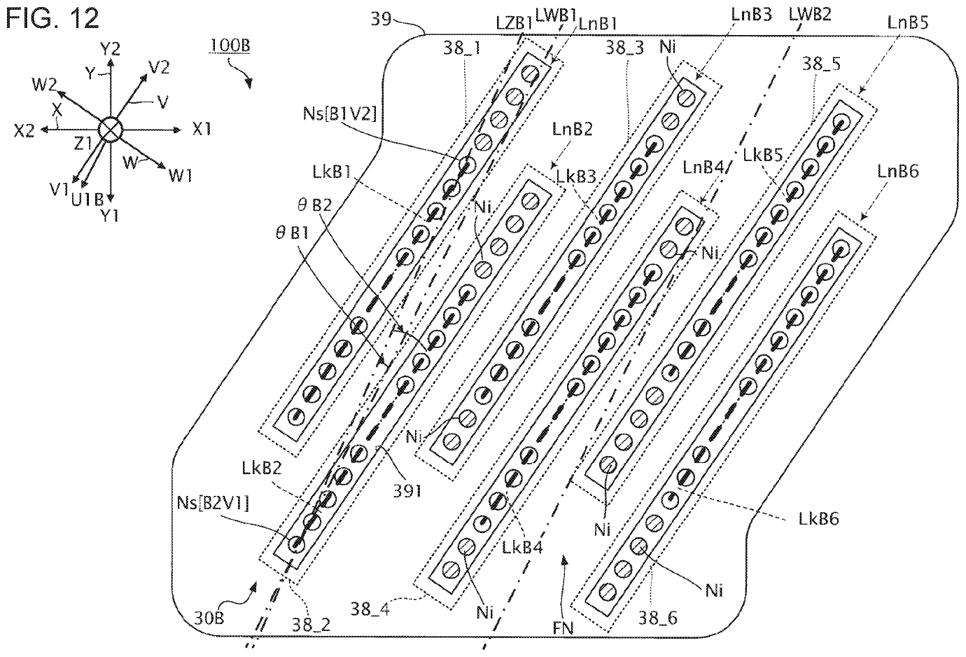

FIG. 12 is a diagram illustrating the blowing direction of the air blowing mechanism 96 in the first modification example. A liquid ejecting apparatus 100B according to the first modification example is different from the liquid ejecting apparatus 100 in that a liquid ejecting head 30B is included instead of the liquid ejecting head 30. The liquid ejecting head 30B is different from the liquid ejecting head 30 in that the liquid ejecting head 30B includes the unused nozzle Ni. In FIG. 12, the unused nozzles Ni are hatched.

In FIG. 12, for any variable i from 1 to 6, the nozzle array Ln including the M nozzles N included in the head chip 38_i of the liquid ejecting head 30B may be referred to as a nozzle array LnBi. In the example of FIG. 12, four nozzles N disposed at the end portion of the nozzle array LnB1 in the V2 direction, four nozzles N disposed at the end portion of the nozzle array LnB2 in the V2 direction, two nozzles N disposed at the end portion of the nozzle array LnB3 in the V1 direction, two nozzles N disposed at the end portion of the nozzle array LnB3 in the V2 direction, two nozzles N disposed at the end portion of the nozzle array LnB4 in the V1 direction, two nozzles N disposed at the end portion of the nozzle array LnB4 in the V2 direction, four nozzles N disposed at the end portion of the nozzle array LnB5 in the V1 direction, and four nozzles N disposed at the end portion of the nozzle array LnB6 in the V1 direction are the unused nozzles Ni. However, there may be the nozzle array LnB in which the unused nozzle Ni is not included among the plurality of nozzle arrays LnB.

In FIG. 12, virtual straight lines LWB1 and LWB2 projected on the ejection surface FN are illustrated. Hereinafter, the virtual straight line LWB1 and the virtual straight line LWB2 may be collectively referred to as a virtual straight line LWB without distinction. The virtual straight line LWB is a straight line that extends in a U1B direction that is a direction in which the airflow generated by the air blowing mechanism 96 flows. That is, the airflow generated by the air blowing mechanism 96 flows in the U1B direction along the virtual straight line LWB at a position facing the ejection surface FN.

In FIG. 12, a nozzle line segment LkB coupling the used nozzle Ns disposed at the end in the V1 direction and the used nozzle Ns disposed at the end in the V2 direction that is a direction opposite to the V1 direction is illustrated for all of the nozzle arrays LnB included in the liquid ejecting head 30B. In the example of FIG. 12, for any variable i from 1 to 6, the nozzle line segment corresponding to the head chip 38_i included in the liquid ejecting head 30B is referred to as a nozzle line segment LkBi. Hereinafter, the nozzle line segments LkBi may be collectively referred to as a nozzle line segment LkB without distinction. Since each of the head chips 38 includes (M-4) used nozzles Ns obtained by subtracting four unused nozzles Ni from the M nozzles N, the six nozzle line segments LkB have the same length.

As in the first embodiment, the number of the nozzle line segments LkB overlapping the virtual straight line LWB is 1 or less regardless of the position of the virtual straight line LWB in the direction along the X axis. Specifically, the number of the nozzle line segments LkB overlapping the virtual straight line LWB1 is one, that is, the nozzle line segment Lkb2. The number of the nozzle line segments LkB overlapping the virtual straight line LWB2 is zero.

The virtual straight line LWB may overlap one or a plurality of unused nozzles Ni. Specifically, the virtual straight line LWB1 overlaps two unused nozzles Ni disposed at the end portion of the nozzle array LnB1 in the V2 direction. The virtual straight line LWB2 does not overlap the unused nozzle Ni.

In addition, in FIG. 12, a first straight line LZB1 is illustrated. The first straight line LZB1 passes through the used nozzle Ns[B2V1] disposed at the end in the V1 direction in the nozzle array LnB2 and the used nozzle Ns[B1V2] disposed at the end in the V2 direction in the nozzle array LnB1. A first angle θB1 formed between the virtual straight line LWB1 and the first straight line LZB1 is equal to or less than half of a second angle θB2 formed between the first straight line LZB1 and the nozzle line segment Lkb4.

### 3-1-2. Summary of First Modification Example

The plurality of nozzles N include one or more unused nozzles Ni that are not used for the printing operation, and the virtual straight line LWB may overlap any one or a plurality of unused nozzles Ni among the one or more unused nozzles Ni.

According to the first modification example, as in the second embodiment, the first angle θB1 can be reduced, so that the airflow generated by the air blowing mechanism 96 can be uniformly applied to each used nozzle Ns of the nozzle array Ln.

### 3-2. Second Modification Example

In each of the above aspects, the interval dw1 in the W axis between the two nozzle arrays Ln adjacent in the W axis in one liquid ejecting head 30 is substantially the same for all cases, but the present disclosure is not limited to this. Hereinafter, a second modification example will be described.

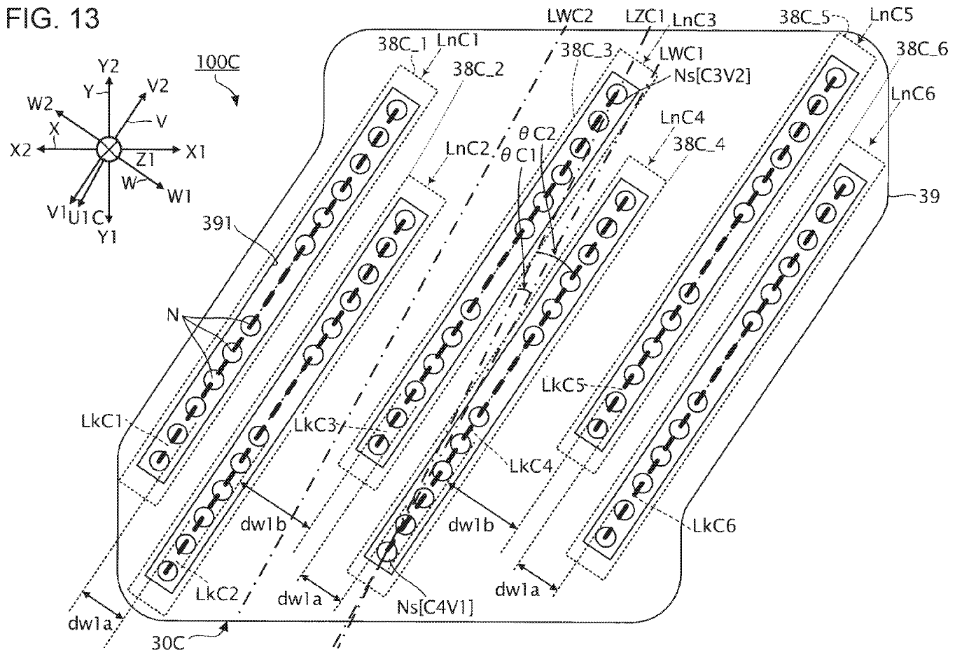

FIG. 13 is a diagram illustrating the blowing direction of the air blowing mechanism 96 in the second modification example. A liquid ejecting apparatus 100C according to the second modification example is different from the liquid ejecting apparatus 100 in that a liquid ejecting head 30C is included instead of the liquid ejecting head 30. The liquid ejecting head 30C is different from the liquid ejecting head 30 in that six head chips 38C are included instead of the six head chips 38. However, each of the six head chips 38C is different from the head chip 38 only in the disposition with respect to the ejection surface FN in plan view. When the six head chips 38C are distinguished, the head chips 38C are referred to as head chips 38C_1, 38C_2, 38C_3, 38C_4, 38C_5, and 38C_6.

Each of the six head chips 38C includes a nozzle array LnC. The nozzle array LnC includes M nozzles N that are arranged in the V2 direction. Hereinafter, for any variable i from 1 to 6, the nozzle array Ln including the M nozzles N included in the head chip 38C_i may be referred to as a nozzle array LnCi. Among the intervals between the nozzle array LnCi and the nozzle array LnC of the head chip 38C_i+1, in which i is an integer from 1 to 5, an interval dw1a between two nozzle arrays LnC adjacent along the Y axis in the W axis is the narrowest. Specifically, as an example of the two nozzle arrays LnC adjacent along the Y axis, the interval dw1a between the nozzle array LnC1 and the nozzle array LnC2 in the W axis is narrower than an interval dw1b between the nozzle array LnC2 and the nozzle array LnC3 in the W axis.

In FIG. 13, virtual straight lines LWC1 and LWC2 projected on the ejection surface FN are illustrated. Hereinafter, the virtual straight lines LWC1 and LWC2 may be collectively referred to as a virtual straight line LWC without distinction. The virtual straight line LWC is a straight line that extends in a U1C direction that is a direction in which the airflow generated by the air blowing mechanism 96 flows. That is, the airflow generated by the air blowing mechanism 96 flows in the U1C direction along the virtual straight line LWC at a position facing the ejection surface FN.

In FIG. 13, a nozzle line segment LkC coupling the used nozzle Ns disposed at the end in the V1 direction and the used nozzle Ns disposed at the end in the V2 direction that is a direction opposite to the V1 direction is illustrated for all of the nozzle arrays LnC included in the liquid ejecting head 30C. In the example of FIG. 13, for any variable i from 1 to 6, the nozzle line segment corresponding to the head chip 38C_i included in the liquid ejecting head 30C is referred to as a nozzle line segment LkCi. Hereinafter, the nozzle line segments LkCi may be collectively referred to as a nozzle line segment LkC without distinction.

In the second modification example, the interval dw1a is narrower than the interval dw1b. Therefore, the manufacturer of the liquid ejecting apparatus 100C adjusts the blowing direction of the airflow generated by the air blowing mechanism 96 such that the variation in the landing position due to the self-jet flow of each nozzle N of the nozzle array Ln located in the Y1 direction among the two nozzle arrays Ln at both ends of the interval dw1a pk is suppressed.

As in the first embodiment, the number of the nozzle line segments LkC overlapping the virtual straight line LWC is 1 or less regardless of the position of the virtual straight line LWC in the direction along the X axis. Specifically, the number of the nozzle line segments LkC overlapping the virtual straight line LWC1 is one, that is, the nozzle line segment Lkc4. The number of the nozzle line segments LkC overlapping the virtual straight line LWC2 is zero.

In addition, in FIG. 13, a first straight line LZC1 is illustrated. The first straight line LZC1 passes through the used nozzle Ns[C4V1] disposed at the end in the V1 direction in the nozzle array LnC4 and the used nozzle Ns[C3V2] disposed at the end in the V2 direction in the nozzle array LnC3. A first angle θC1 formed between the virtual straight line LWC1 and the first straight line LZC1 is equal to or less than half of a second angle θC2 formed between the first straight line LZC1 and the nozzle line segment Lkc4. In the second modification example, the nozzle array LnC4 is an example of a “first nozzle array”, and the nozzle array LnD3 is an example of a “second nozzle array”.

In the liquid ejecting apparatus 100C according to the second modification example, the nozzle array LnC4 corresponding to the “first nozzle array” and the nozzle array LnC3 corresponding to the “second nozzle array” are the two nozzle arrays LnC having the narrowest interval in the direction along the W axis among the six nozzle arrays LnC.

According to the second modification example, since the variation in the landing position due to the self-jet flow of each nozzle N of the nozzle array LnC4 located in the Y1 direction among the two nozzle arrays LnC having the narrowest interval in the direction along the W axis can be suppressed, the airflow generated by the air blowing mechanism 96 can be uniformly applied to each nozzle N of the six nozzle arrays LnC.

### 3-3. Third Modification Example

In the aspect other than the second embodiment among the above aspects, the plurality of head chips 38 are arranged in a staggered manner, but the present disclosure is not limited to this. Hereinafter, a third modification example will be described.

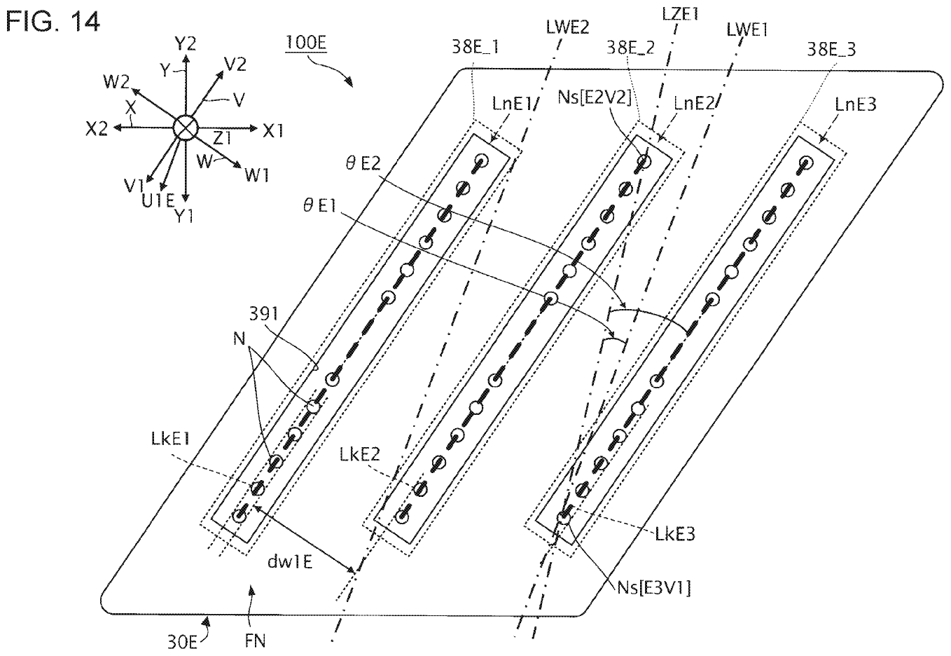

FIG. 14 is a diagram illustrating the blowing direction of the air blowing mechanism 96 in the third modification example. A liquid ejecting apparatus 100E according to the third modification example is different from the liquid ejecting apparatus 100 in that a liquid ejecting head 30E is included instead of the liquid ejecting head 30. The liquid ejecting head 30E is different from the liquid ejecting head 30 in that three head chips 38E are included instead of the six head chips 38. However, each of the three head chips 38E has the same function as the head chip 38. Hereinafter, the head chips 38E will be described as head chips 38E_1, 38E_2, and 38E_3 when the head chips 38E are distinguished. The three head chips 38E are arranged along the X axis.

Each of the three head chips 38E includes a nozzle array LnE. The nozzle array LnE includes M nozzles N that are arranged in the V2 direction. Hereinafter, for any variable i from 1 to 3, the nozzle array Ln including the M nozzles N included in the head chip 38E_i may be referred to as a nozzle array LnEi. An interval dw1E in the W axis between the two nozzle arrays LnE adjacent in the W axis in one liquid ejecting head 30E is substantially the same for all cases.

The three nozzle arrays LnE are arranged in the direction along the X axis. Among the three nozzle arrays LnE, two adjacent nozzle arrays LnE at least partially overlap each other when viewed in the Y1 direction. Therefore, as in the first embodiment, in an aspect in which the air blowing mechanism 96 is not provided, the transport airflow is likely to be difficult to reach the nozzle N located downstream of the transport airflow among the nozzles N of the two adjacent nozzle arrays LnE, and thus the variation in the landing position due to the self-jet flow occurs. Therefore, in the third modification example, the variation in the landing position due to the self-jet flow can be suppressed by including the air blowing mechanism 96.

In FIG. 14, virtual straight lines LWE1 and LWE2 projected on the ejection surface FN are illustrated. Hereinafter, the virtual straight lines LWE1 and LWE2 may be collectively referred to as a virtual straight line LWE without distinction. The virtual straight line LWE is a straight line that extends in a U1E direction that is a direction in which the airflow generated by the air blowing mechanism 96 flows. That is, the airflow generated by the air blowing mechanism 96 flows in the U1E direction along the virtual straight line LWE at a position facing the ejection surface FN.

In FIG. 14, a nozzle line segment LkE coupling the used nozzle Ns disposed at the end in the V1 direction and the used nozzle Ns disposed at the end in the V2 direction is illustrated for all of the nozzle arrays LnE included in the liquid ejecting head 30E. In the example of FIG. 14, for any variable i from 1 to 3, the nozzle line segment corresponding to the head chip 38E_i included in the liquid ejecting head 30E is referred to as a nozzle line segment LkEi. Hereinafter, the nozzle line segments LkEi may be collectively referred to as a nozzle line segment LkE without distinction.

The number of the nozzle line segments LkE overlapping the virtual straight line LWE is 1 or less regardless of the position of the virtual straight line LWE in the direction along the X axis. Specifically, the number of the nozzle line segments LkE overlapping the virtual straight line LWE1 is one, that is, the nozzle line segment Lke3. The number of the nozzle line segments LkE overlapping the virtual straight line LWE2 is zero.

In addition, in FIG. 14, a first straight line LZE1 is illustrated. The first straight line LZE1 passes through the used nozzle Ns[E3V1] disposed at the end in the V1 direction in the nozzle array LnE3 and the used nozzle Ns[E2V2] disposed at the end in the V2 direction in the nozzle array LnE2. A first angle θE1 formed between the virtual straight line LWE1 and the first straight line LZE1 is equal to or less than half of a second angle θE2 formed between the first straight line LZE1 and the nozzle line segment Lke3.

### 3-4. Fourth Modification Example

In the second embodiment, one head chip 38A includes two nozzle arrays Ln, but the number of the nozzle arrays Ln included in one head chip 38A may be 3 or more. Hereinafter, a fourth modification example will be described.

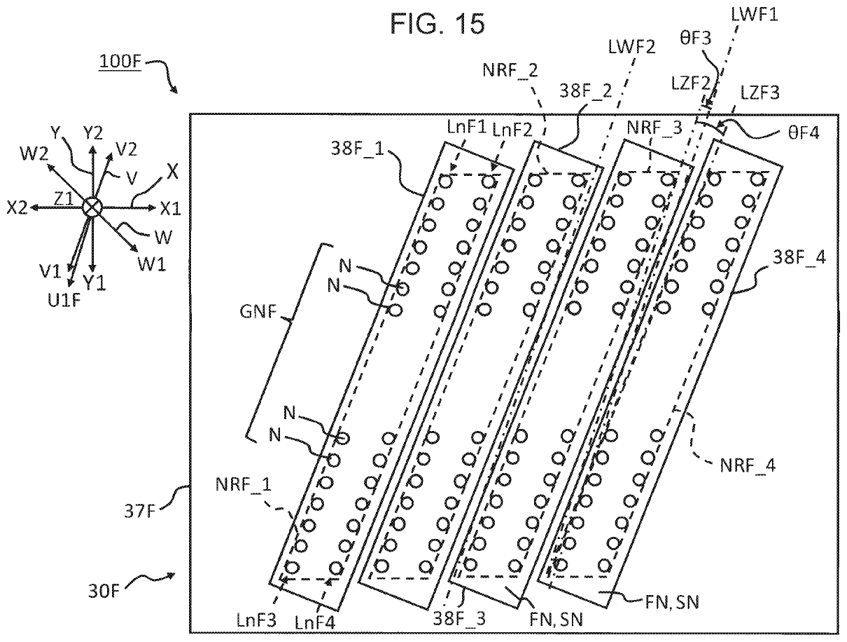

FIG. 15 is a diagram illustrating the blowing direction of the air blowing mechanism 96 in the fourth modification example. A liquid ejecting apparatus 100F according to the fourth modification example is different from the liquid ejecting apparatus 100 in that a liquid ejecting head 30F is included instead of the liquid ejecting head 30. The liquid ejecting head 30F is different from the liquid ejecting head 30 in that the liquid ejecting head 30F includes four head chips 38F instead of the head chips 38. In the present modification example, the plurality of head chips 38F are fixed to the same holder 37, and the plurality of nozzle surfaces SN provided in each of the plurality of head chips 38F fixed to the same holder 37F constitute one ejection surface FN. That is, as can be understood from FIG. 15, the ejection surface FN of the liquid ejecting head 30F may include the plurality of nozzle surfaces SN disposed at intervals, and need not be one continuous surface. In addition, although four head chips 38F are illustrated in FIG. 15, the number of the head chips 38F provided in the liquid ejecting head 30F is arbitrary. The four head chips 38F are an example of a “plurality of head chips”.

Each of the four head chips 38F is different from the head chip 38 in that the head chip 38F includes a nozzle array LnF1 and a nozzle array LnF3 that are arranged at an interval in the direction along the V axis, and a nozzle array LnF2 and a nozzle array LnF4 that are arranged at an interval in the direction along the V axis. The nozzle array LnF1 and the nozzle array LnF3 are disposed on substantially the same straight line in the direction along the V axis.

The nozzle array LnF2 and the nozzle array LnF4 are disposed on substantially the same straight line in the direction along the V axis. In addition, the nozzle array LnF1 and the nozzle array LnF2 are arranged at an interval in the direction along the X axis, and the nozzle array LnF3 and the nozzle array LnF4 are arranged at an interval in the direction along the X axis. Hereinafter, the nozzle arrays LnF1 to LnF4 may be collectively referred to as a nozzle array LnF without distinction. In order to prevent the drawing from being complicated, reference numerals are given only to some of the nozzles N included in the nozzle group GNF.

In the fourth modification example, all of the plurality of nozzles N included in the liquid ejecting apparatus 100F are the used nozzles Ns. FIG. 15 illustrates a nozzle region NRF surrounded by the smallest convex polygon surrounding the used nozzle Ns included in the nozzle group GNF included in one head chip 38F. Furthermore, for ease of understanding, for any variable i from 1 to 4, the nozzle region NRF surrounded by the smallest convex polygon surrounding all of the plurality of used nozzles Ns included in the nozzle group GNF included in the head chip 38F_i may be referred to as a nozzle region NRF_i. The nozzle region NRF is elongated in the V1 direction.

The four nozzle regions NRF are arranged in the direction along the X axis. In the four nozzle regions NRF, two adjacent nozzle regions NRF at least partially overlap each other when viewed in the Y1 direction.

In the fourth modification example, the air blowing mechanism 96 generates the airflow along the ejection surface FN in the U1F direction intersecting all of the Y1 direction, the direction along the X axis, and the V1 direction. In the fourth modification example, the U1F direction is an example of a “third direction”.

In FIG. 15, virtual straight lines LWF1 and LWF2 projected on the ejection surface FN are illustrated. Hereinafter, the virtual straight lines LWF1 and LWF2 may be collectively referred to as a virtual straight line LWF without distinction. The virtual straight line LWF is a straight line that extends in the U1F direction. That is, the airflow generated by the air blowing mechanism 96 flows in the U1F direction along the virtual straight line LWF at a position facing the ejection surface FN. The virtual straight line LWF may be projected on the ejection surface FN at any position in the direction along the X axis, but in FIG. 11, in order to prevent the drawing from being complicated, only the virtual straight lines LWF1 and LWF2 are illustrated.

As can be understood from FIG. 15, the number of the nozzle regions NRF overlapping the virtual straight line LWF among the four nozzle regions NRF is 1 or less regardless of the position of the virtual straight line LWF in the direction along the X axis. Specifically, the virtual straight line LWF1 passes through the nozzle N disposed at the end portion of the nozzle region NRF_4 in the V1 direction, more specifically, the end portion of the nozzle array LnF4 in the V1 direction in plan view. Therefore, the number of the nozzle regions NRF overlapping the virtual straight line LWF1 is one, that is, the nozzle region NRF_4. The virtual straight line LWF2 passes between the nozzle region NRF_2 and the nozzle region NRF_3 in plan view. Therefore, the number of the nozzle regions NRF overlapping the virtual straight line LWF2 is zero.

In addition, in FIG. 15, a second straight line LZF2 and a third straight line LZF3 are illustrated. The second straight line LZF2 is a straight line that is externally tangent to the end portion of the nozzle region NRF_4 in the V1 direction and the end portion of the nozzle region NRF_3 in the V2 direction. The third straight line LZF3 is a straight line that extends in the V1 direction along a long side of the nozzle region NRF_4. A third angle θF3 formed between the virtual straight line LWF1 and the second straight line LZF2 is equal to or less than half of a fourth angle θF4 formed between the second straight line LZF2 and the third straight line LZF3. The smaller the third angle θF3, the more preferable it is, and for example, it is preferable that the third angle θF3 is less than half of the fourth angle θF4. The nozzle group GNF included in the head chip 38F_4 is an example of a “first nozzle group”, and the nozzle group GNF included in the head chip 38F_3 is an example of a “second nozzle group”. The nozzle region NRF_4 is an example of a “nozzle region corresponding to the first nozzle group”, and the nozzle region NRF_3 is an example of a “nozzle region corresponding to the second nozzle group”.

In addition, the second straight line LZF2 is externally tangent to the nozzle region NRF_3 and the nozzle region NRF_4, and is not tangent to or does not overlap the other nozzle regions NRF other than the nozzle region NRF_3 and the nozzle region NRF_4.

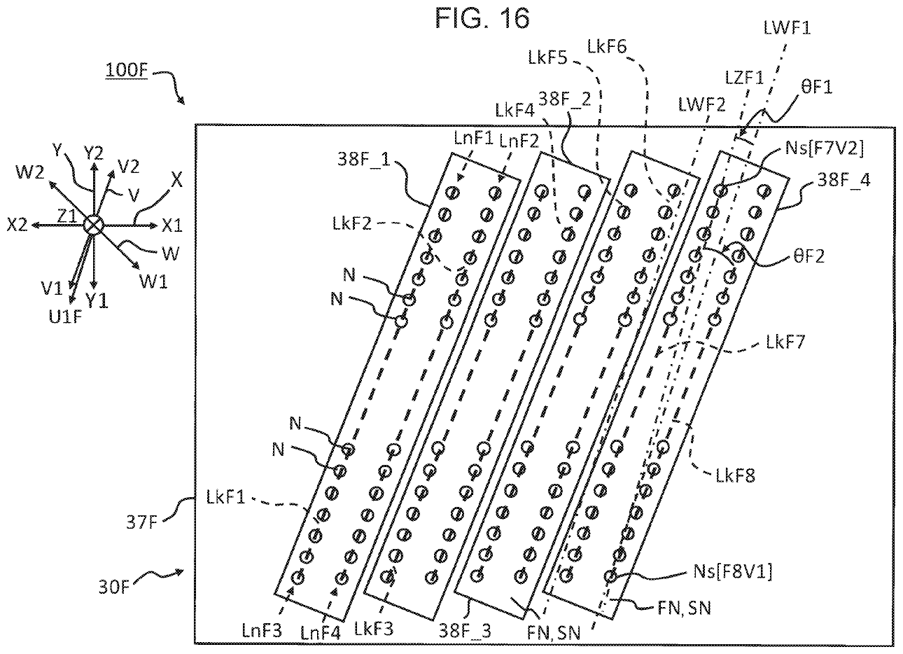

Next, FIG. 16 will be described. The liquid ejecting head 30F illustrated in FIG. 15 and the liquid ejecting head 30F illustrated in FIG. 16 are the same. As illustrated in FIG. 16, for each head chip 38F, the nozzle arrays LnF1 and LnF3 disposed at an interval along the V axis may be regarded as one nozzle array LnF, and the nozzle arrays LnF2 and LnF4 disposed at an interval along the V axis may be regarded as one nozzle array LnF. Accordingly, a line segment coupling the nozzle N disposed at the end portion of the nozzle array LnF1 in the V2 direction and the nozzle N disposed at the end portion of the nozzle array LnF3 in the V1 direction is A nozzle line segment LkF. In the present modification example, a total of eight nozzle line segments LkF are provided, and the nozzle line segments LkF1, LkF2, LkF3, LkF4, LkF5, LkF6, LkF7, and LkF8 are arranged in this order in the X1 direction.

In FIG. 16, virtual straight lines LWF1 and LWF2 obtained by projecting a straight line that extends in the U1F direction on the ejection surface FN are illustrated. The virtual straight lines are referred to as a virtual straight line LWF when the virtual straight lines LWF1 and LWF2 are not distinguished. As can be understood from FIG. 16, the number of the nozzle line segments LkF overlapping the virtual straight line LWF among the eight nozzle line segments LkF is 1 or less regardless of the position of the virtual straight line LWF in the direction along the X axis. Specifically, the virtual straight line LWF1 passes through the nozzle line segment LkF8 in plan view. Therefore, the number of the nozzle line segments LkF overlapping the virtual straight line LWF1 is one, that is, the nozzle line segment LKF8. The virtual straight line LWF2 passes between the nozzle line segment LKF6 and the nozzle line segment LKF7 in plan view. Therefore, the number of the nozzle line segments LKF overlapping the virtual straight line LWF2 is zero.

In addition, in FIG. 16, a first straight line LZF1 is illustrated. The first straight line LZF1 is a straight line that passes through a nozzle Ns[F8V1] disposed at the end in the V1 direction of the nozzle array LnF corresponding to the nozzle line segment LkF8 and a nozzle Ns[F7V2] disposed at the end in the V2 direction of the nozzle array LnF corresponding to the nozzle line segment LkF7. A first angle θF1 formed between the virtual straight line LWF1 and the first straight line LZF1 is equal to or less than half of a second angle θF2 formed between the first straight line LZF1 and the nozzle line segment LkF8. The smaller the first angle θF1, the more preferable it is, and for example, it is preferable that the first angle θF1 is less than half of the second angle θF2. The nozzle array LnF corresponding to the nozzle line segment LkF8 is an example of a “first nozzle array”, and the nozzle array LnF corresponding to the nozzle line segment LkF7 is an example of a “second nozzle array”. The nozzle Ns[F8V1] is an example of a “first used nozzle”, and the nozzle Ns[F7V2] is an example of a “second used nozzle”.

In the present modification example, the distances between the nozzle line segments LkF adjacent in the direction along the X axis are all equal. Therefore, the nozzle array LnF corresponding to the nozzle line segment LkF7 may be an example of a “first nozzle array”, and the nozzle array LnF corresponding to the nozzle line segment LkF6 may be an example of a “second nozzle array”.

In addition, the first straight line LZF1 is not tangent to or does not overlap the other nozzle line segments LkF other than the nozzle line segments LkF7 and LkF8.

### 3-5. Fifth Modification Example

In each of the above aspects, the liquid ejecting head 30 constitutes the line head, but the present disclosure is not limited to this. For example, the present disclosure can also be applied to a serial type in which the liquid ejecting head 30 reciprocates along the X axis.

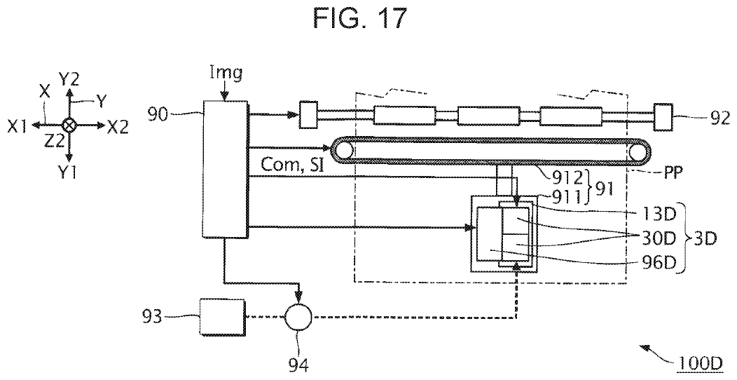

FIG. 17 is an explanatory diagram illustrating an example of a liquid ejecting apparatus 100D according to a fifth modification example. The liquid ejecting apparatus 100D is different from the liquid ejecting apparatus 100 in that the liquid ejecting apparatus 100D includes a head module 3D instead of the head module 3 and further includes a movement mechanism 91.

The movement mechanism 91 reciprocates the head module 3D along the X axis under the control of the control device 90. As illustrated in FIG. 17, the movement mechanism 91 includes a substantially box-shaped carriage 911 on which the head module 3D is mounted and an endless belt 912 on which the head module 3D is fixed. A configuration may also be adopted in which the liquid container 93 and the circulation mechanism 94 are mounted on the carriage 911 together with the head module 3D.

The head module 3D is only rotated 90 degrees counterclockwise about the Z axis when viewed in the Z1 direction with respect to the orientation of the head module 3, and the shape and function are the same as those of the head module 3. The head module 3D includes a plurality of liquid ejecting heads 30D, a head fixing substrate 13D that holds the plurality of liquid ejecting heads 30D, and an air blowing mechanism 96D. The liquid ejecting head 30D, the head fixing substrate 13D, and the air blowing mechanism 96D are only rotated 90 degrees counterclockwise about the Z axis when viewed in the Z2 direction with respect to the orientations of the liquid ejecting head 30, the head fixing substrate 13, and the air blowing mechanism 96, respectively, and thus the description thereof will be omitted.

The airflow is generated by the movement of the head module 3D along the X axis. Hereinafter, the airflow generated by the movement of the head module 3D along the X axis may be referred to as a “movement airflow”. The occurrence of the wind ripples due to the self-jet flow can be suppressed by the movement airflow. However, when the nozzle array Ln is inclined with respect to the X axis, the plurality of nozzles N include the nozzle N located upstream of the movement airflow and the nozzle N located downstream of the movement airflow, and in the nozzle N located downstream of the movement airflow, the occurrence of the wind ripples due to the self-jet flow by the movement airflow may not be suppressed. Therefore, in the fifth modification example, as in the first embodiment, the air blowing mechanism 96D is provided to uniformly apply the airflow to each nozzle N of the nozzle array Ln to suppress the variation in the landing position.

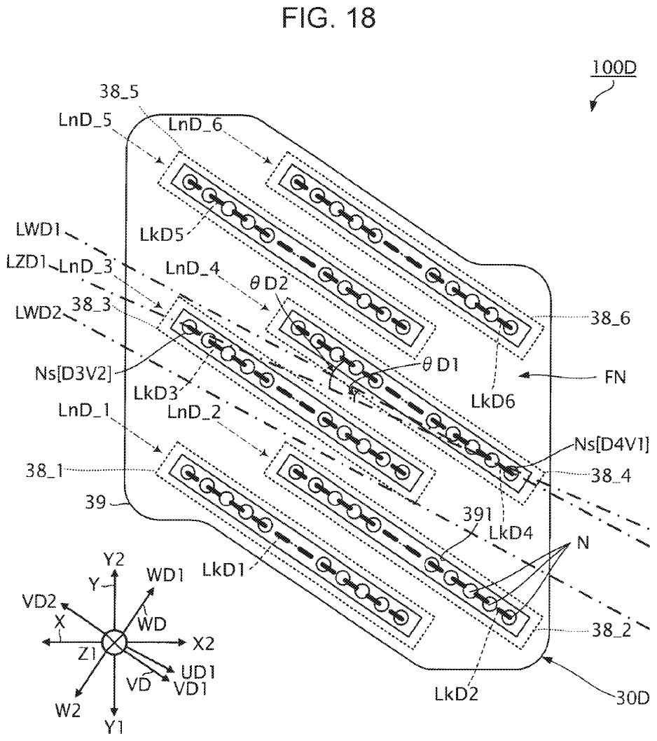

FIG. 18 is a diagram illustrating the blowing direction of the air blowing mechanism 96D in the fifth modification example.

In FIG. 18, in order to prevent the drawing from being complicated, only one liquid ejecting head 30D is illustrated.

The nozzle array direction of each of the six head chips 38 included in the liquid ejecting head 30D is a VD1 direction obtained by rotating the V1 direction 90 degrees counterclockwise about the Z axis when viewed in the Z2 direction. In FIG. 18, a direction opposite to the VD1 direction is referred to as a VD2 direction. Further, the VD1 direction and the VD2 direction may be collectively referred to as a direction along a VD axis. Further, a direction perpendicular to the direction along the Z axis and the direction along the VD axis is referred to as a WD1 direction and a WD2 direction. The WD1 direction is the direction between the X2 direction and the Y2 direction, and the WD2 direction is the direction between the X1 direction and the Y1 direction. The WD1 direction and the WD2 direction may be collectively referred to as a direction along a WD axis.

Further, in FIG. 18, virtual straight lines LWD1 and LWD2 projected on the ejection surface FN are illustrated. Hereinafter, the virtual straight lines LWD1 and LWD2 may be collectively referred to as a virtual straight line LWD without distinction. The virtual straight line LWD is a straight line that extends in the UD1 direction. That is, the airflow generated by the air blowing mechanism 96 flows in the UD1 direction along the virtual straight line LWD at a position facing the ejection surface FN. The UD1 direction intersects all of the Y1 direction, the direction along the X axis, and the VD1 direction that is the nozzle array direction. The UD1 direction is an example of a “third direction”.

The nozzle arrays LnD of the six head chips 38 are arranged in the Y1 direction. For ease of description, for any variable i from 1 to 6, the nozzle array LnD included in the head chip 38_i of the liquid ejecting head 30D may be referred to as a nozzle array LnD_i. In addition, the nozzle arrays LnD_1 to LnD_6 may be collectively referred to as a nozzle array LnD without distinction. Two adjacent nozzle arrays LnD among the six nozzle arrays LnD included in the liquid ejecting head 30D at least partially overlap each other when viewed in the direction along the X axis. For example, when viewed in the direction along the X axis, the nozzle array LnD_1 and the nozzle array LnD_2 completely overlap each other. In addition, when viewed in the direction along the X axis, a part of the nozzle array LnD_2 and a part of the nozzle array LnD_3 overlap each other.

In addition, a nozzle line segment LkD coupling the used nozzle Ns disposed at the end in the VD1 direction and the used nozzle Ns disposed at the end in the VD2 direction that is a direction opposite to the VD1 direction is illustrated for all of the nozzle arrays LnD included in the liquid ejecting head 30D. In the example of FIG. 18, for any variable i from 1 to 6, the nozzle line segment corresponding to the head chip 38_i included in the liquid ejecting head 30D is referred to as a nozzle line segment LkDi. Hereinafter, the nozzle line segments LkDi may be collectively referred to as a nozzle line segment LkD without distinction.

In addition, in FIG. 18, a first straight line LZD1 is illustrated. The first straight line LZD1 passes through the used nozzle Ns[D4V1] disposed at the end in the VD1 direction in the nozzle array LnD_4 and the used nozzle Ns[D3V2] disposed at the end in the VD2 direction in the nozzle array LnD_3. A first angle θD1 formed between the virtual straight line LWD1 and the first straight line LZD1 is equal to or less than half of a second angle θD2 formed between the first straight line LZD1 and the nozzle line segment LkD4. In the fifth modification example, the nozzle array LnD_4 is an example of a “first nozzle array”, and the nozzle array LnD_3 is an example of a “second nozzle array”.

In addition, as in the first embodiment, among the combinations of selecting two nozzle line segments LkD from the six nozzle line segments LkD, a pair of two nozzle line segments LkD having the greatest overlapping amount when viewed in the direction along the X axis are two nozzle line segments LkD adjacent along the X axis. Specifically, the pairs of two nozzle line segments LkD having the greatest overlapping amount are a pair of the nozzle line segment LkD1 and the nozzle line segment LkD2, a pair of the nozzle line segment LkD3 and the nozzle line segment LkD4, and a pair of the nozzle line segment LkD5 and the nozzle line segment LkD6. Therefore, when the nozzle array LnD_4 corresponds to the “first nozzle array” and the nozzle array LnD_3 corresponds to the “second nozzle array”, the nozzle line segment LkD4 corresponding to the nozzle array LnD_4 and the nozzle line segment LkD3 corresponding to the nozzle array LnD_3 constitute, among the combinations of selecting two nozzle line segments LkD from the nozzle line segments LkD corresponding to each nozzle array Ln of the six nozzle arrays LnD, a pair having the greatest overlapping amount when viewed in the Y1 direction.

The liquid ejecting apparatus 100D according to the fifth modification example includes the carriage 911 on which the liquid ejecting head 30D is mounted and that reciprocates along the direction along the X axis, the plurality of nozzle arrays LnD of the liquid ejecting head 30D are arranged in the Y1 direction, and two adjacent nozzle arrays LnD among the plurality of nozzle arrays LnD of the liquid ejecting head 30D at least partially overlap each other when viewed in the direction along the X axis.

According to the fifth modification example, the variation in the landing position due to the self-jet flow can be suppressed even in the serial type. In the present modification example, the Y1 direction is an example of a “first direction”, and the X1 direction is an example of a “second direction”.

### 3-6. Sixth Modification Example

The liquid ejecting head 30D illustrated in the third modification example is the aspect in which the liquid ejecting head 30 according to the first embodiment is rotated 90 degrees counterclockwise about the Z axis when viewed in the Z2 direction, but the present disclosure is not limited to this. For example, in order to apply the serial type, the liquid ejecting head 30A according to the aspects other than the first embodiment, for example, the second embodiment may be rotated 90 degrees counterclockwise about the Z axis when viewed in the Z2 direction.

### 3-7. Seventh Modification Example

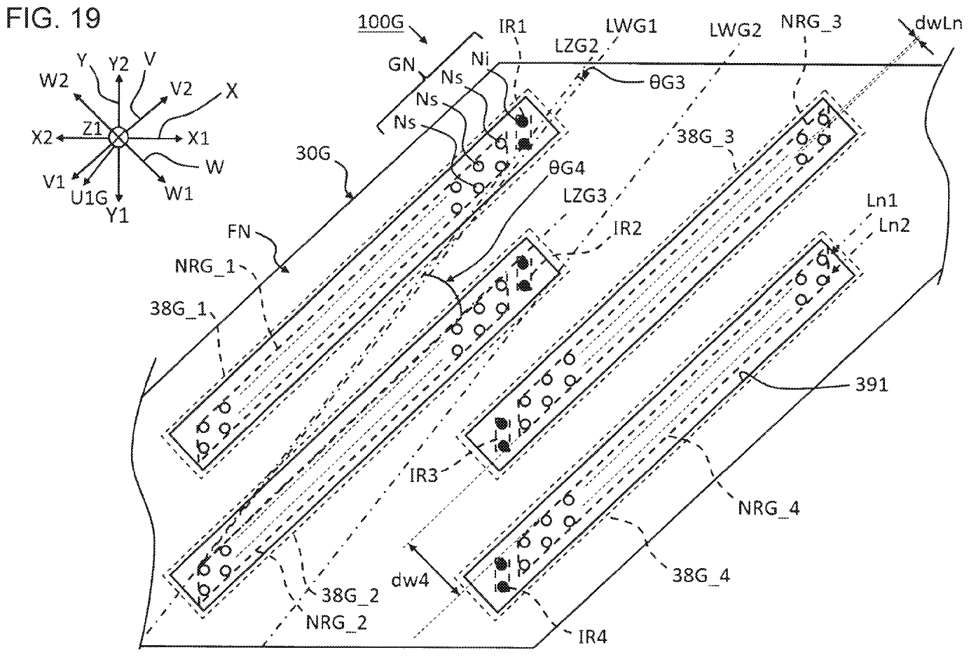

FIG. 19 is a diagram illustrating the blowing direction of the air blowing mechanism 96 in a seventh modification example that is a modification example of the second embodiment. A liquid ejecting apparatus 100G according to the seventh modification example is different from the liquid ejecting apparatus 100A in that a liquid ejecting head 30G is included instead of the liquid ejecting head 30A. The liquid ejecting head 30G is different from the liquid ejecting head 30A in that the liquid ejecting head 30G includes four head chips 38G instead of the three head chips 38A. The four head chips 38G are an example of a “plurality of head chips”. In the present modification example, the liquid ejecting head 30G includes the four head chips 38G, but need only include two or more head chips 38G.

The liquid ejecting head 30G includes head chips 38G_1 to 38G_4 as the four head chips 38G. The head chips 38G_1 to 38G_4 are disposed in this order along the X1.

Each of the four head chips 38G includes the nozzle group GN including 2M nozzles N that are divided into the nozzle array Ln1 and the nozzle array Ln2 that are arranged at an interval in the direction along the W axis. Hereinafter, the nozzle arrays Ln1 and Ln2 may be collectively referred to as a nozzle array Ln without distinction. In order to prevent the drawing from being complicated, reference numerals are given only to some of the nozzles N included in the nozzle group GN. In the present modification example, among the plurality of nozzles N included in the liquid ejecting apparatus 100G, some are the used nozzles Ns, and the remaining some are the unused nozzles Ni. In FIG. 19, the unused nozzles Ni are indicated by black circles. In FIG. 19, two unused nozzles Ni are provided in one head chip 38G.

An interval dw4 between the two adjacent nozzle regions NR in the W axis in the liquid ejecting head 30G is substantially the same for all cases. In addition, the interval dw4 is sufficiently wider than the interval dwLn between the two nozzle arrays Ln included in one head chip 38G.

FIG. 19 illustrates a smallest convex polygon surrounding all of the used nozzles Ns included in the nozzle group GN included in one head chip 38G. In FIG. 19, the convex polygon is a parallelogram. Hereinafter, the region surrounded by the convex polygon may be referred to as a nozzle region NRG. Furthermore, for ease of understanding, for any variable i from 1 to 4, the nozzle region NRG surrounded by the smallest convex polygon surrounding (2M-2) used nozzles Ns included in the nozzle group GN included in the head chip 38G_i may be referred to as a nozzle region NRG_i. The nozzle region NRG is elongated in the V1 direction. The V1 direction is an example of a “fourth direction”.

FIG. 19 illustrates a smallest convex polygon surrounding the unused nozzles Ni included in one head chip 38G. Hereinafter, the region surrounded by the convex polygon may be referred to as an unused region IR. However, when one head chip 38G includes two or more unused nozzles Ni, the two or more unused nozzles Ni are surrounded by one smallest convex polygon when the two or more unused nozzles Ni are adjacent to each other. In the example of FIG. 19, a plurality of unused regions IR1, IR2, IR3, and IR4 are illustrated as the unused region IR. Two unused nozzles Ni disposed in the V2 direction of the head chip 38G_1 are included in the unused region IR1. Two unused nozzles Ni disposed in the V2 direction of the head chip 38G_2 are included in the unused region IR2. Two unused nozzles Ni disposed in the V1 direction of the head chip 38G_3 are included in the unused region IR3. Two unused nozzles Ni disposed in the V1 direction of the head chip 38G_4 are included in the unused region IR4. In FIG. 19, the unused region IR does not overlap the nozzle region NRG in plan view.

The four nozzle regions NRG are arranged in a staggered manner in the direction along the X axis. In the four nozzle regions NRG, two nozzle regions NRG adjacent in the Y1 direction almost completely overlap each other when viewed in the Y1 direction. The expression “almost completely overlap” means that the two adjacent nozzle regions NRG are displaced relative to each other due to manufacturing errors, or by an amount equal to or less than half of the nozzle pitch in the direction along the X axis of the nozzle arrays Ln in order to increase resolution. When viewed in the Y1 direction, the nozzle region NRG_1 and the nozzle region NRG_2 almost completely overlap each other, and the nozzle region NRG_1 and the nozzle region NRG_3 do not overlap each other. Similarly, when viewed in the Y1 direction, the nozzle region NRG_3 and the nozzle region NRG_4 almost completely overlap each other.

In the present modification example, the air blowing mechanism 96 generates the airflow along the ejection surface FN in the U1G direction intersecting all of the Y1 direction, the direction along the X axis, and the V1 direction. The U1G direction is an example of a “third direction”.

In FIG. 19, virtual straight lines LWG1 and LWG2 projected on the ejection surface FN are illustrated. Hereinafter, the virtual straight lines LWG1 and LWG2 may be collectively referred to as a virtual straight line LWG without distinction. The virtual straight line LWG is a straight line that extends in the U1G direction. That is, the airflow generated by the air blowing mechanism 96 flows in the U1G direction along the virtual straight line LWG at a position facing the ejection surface FN. The virtual straight line LWG may be projected on the ejection surface FN at any position in the direction along the X axis, but in FIG. 19, in order to prevent the drawing from being complicated, only the virtual straight lines LWG1 and LWG2 are illustrated.

As can be understood from FIG. 19, the number of the nozzle regions NRG overlapping the virtual straight line LWG among the four nozzle regions NRG is 1 or less regardless of the position of the virtual straight line LWG in the direction along the X axis. Specifically, the virtual straight line LWG1 passes through the end portion of the nozzle region NRG_2 in the V1 direction in plan view. Therefore, the number of the nozzle regions NRG overlapping the virtual straight line LWG1 is one, that is, the nozzle region NRG_2. The virtual straight line LWG2 passes between the nozzle region NRG_2 and the nozzle region NRG_3 in plan view. Therefore, the number of the nozzle regions NRG overlapping the virtual straight line LWG2 is zero.

In addition, in FIG. 19, a second straight line LZG2 and a third straight line LZG3 are illustrated. The second straight line LZG2 is a straight line that is externally tangent to the end portion of the nozzle region NRG_2 in the V1 direction and the end portion of the nozzle region NRG_1 in the V2 direction. The third straight line LZG3 is a straight line that extends in the V1 direction. A third angle θG3 formed between the virtual straight line LWG1 and the second straight line LZG2 is equal to or less than half of a fourth angle θG4 formed between the second straight line LZG2 and the third straight line LZG3. The smaller the third angle θG3, the more preferable it is, and for example, it is preferable that the third angle θG3 is less than half of the fourth angle θG4. Accordingly, the airflow generated by the air blowing mechanism 96 can be uniformly applied to each used nozzle Ns of the nozzle group GN as compared with the aspect in which the third angle θG3 is equal to or greater than half of the fourth angle θG4. The nozzle group GN included in the head chip 38G_2 is an example of a “first nozzle group”, and the nozzle group GN included in the head chip 38G_1 is an example of a “second nozzle group”. The nozzle region NRG_2 is an example of a “nozzle region corresponding to the first nozzle group”, and the nozzle region NRG_1 is an example of a “nozzle region corresponding to the second nozzle group”.

In addition, the second straight line LZG2 is externally tangent to the nozzle region NRG_1 and the nozzle region NRG_2, and is not tangent to or does not overlap the other nozzle regions NRG other than the nozzle region NRG_1 and the nozzle region NRG_2.

In addition, as can be understood from FIG. 19, a distance between a line segment coupling the end portion of the nozzle region NRG_1 in the V2 direction and the end portion of the nozzle region NRG_2 in the V1 direction is longer than a distance between a line segment coupling the end portion of the nozzle region NRG_1 in the V1 direction and the end portion of the nozzle region NR_2 in the V2 direction.

In addition, among the combinations of selecting two nozzle regions NRG from the four nozzle regions NRG included in one liquid ejecting head 30G, a pair of two nozzle regions NRG having the greatest overlapping amount when viewed in the Y1 direction are two nozzle regions NRG adjacent along the Y axis. Specifically, the pairs of two nozzle regions NRG having the greatest overlapping amount are a pair of the nozzle region NRG_1 and the nozzle region NRG_2 and a pair of the nozzle region NRG_3 and the nozzle region NRG_4.

The virtual straight line LWG may overlap one or a plurality of unused regions IR. Specifically, the virtual straight line LWG1 overlaps the unused region IR1. The virtual straight line LWG2 does not overlap the unused region IR. Since the unused nozzle Ni does not eject the ink during the printing operation, the self-jet flow is not generated in the vicinity of the unused nozzle Ni. That is, since the airflow of the air blowing mechanism 96 easily passes through the unused region IR, the airflow generated by the air blowing mechanism 96 can be uniformly applied to each used nozzle Ns of the nozzle array Ln by overlapping the virtual straight line LWG with the unused region IR to reduce the third angle θG3.

### 3-8. Eighth Modification Example

In each of the above aspects other than the fifth modification example and the sixth modification example, the air blowing mechanism 96 is installed in the Y2 direction of the liquid ejecting head 30, but the present disclosure is not limited to this. For example, a mechanism that suctions the air may be provided in the Y1 direction of the liquid ejecting head 30 instead of or in addition to the air blowing mechanism 96. In addition, the air blowing mechanism 96 may be installed in the Y1 direction of the liquid ejecting head 30, and the airflow may be generated in a direction opposite to the direction of the airflow illustrated in each of the above aspects other than the fifth modification example and the sixth modification example. That is, as in the first embodiment, the airflow may be generated in a direction opposite to the U1 direction by using the air blowing mechanism 96. Similarly, in the fifth modification example and the sixth modification example, the air blowing mechanism 96D is installed in the X1 direction of the liquid ejecting head 30D, but the present disclosure is not limited to this. For example, a mechanism that suctions the air may be provided in the X2 direction of the liquid ejecting head 30D or the liquid ejecting head 30E instead of or in addition to the air blowing mechanism 96D.

### 3-9. Ninth Modification Example

As in the first modification example, when only one nozzle array LnB is provided in one head chip 38B, the one nozzle array LnB may be regarded as the one nozzle group GN described in the eighth modification example, the one nozzle line segment LkB may be regarded as the one nozzle region described in the eighth modification example, and the line segment coupling the unused nozzle Ni disposed at the end portion in the V1 direction and the unused nozzle Ni disposed at the end portion in the V2 direction may be regarded as the unused region IR described in the eighth modification example. When the number of the unused nozzles N1 provided in one nozzle array LnB is one, the one unused nozzle Ni may be regarded as the unused region IR.

### 3-10. Tenth Modification Example

In each of the above aspects, the liquid ejecting head 30 includes the piezoelectric element PZq, but may include a heat generation element instead of the piezoelectric element PZq.

### 3-11. Other Modification Examples

The liquid ejecting apparatus 100 described above can be adopted in various apparatuses such as a facsimile machine and a copy machine, in addition to the apparatus dedicated to printing.

What is claimed is:

1. A liquid ejecting apparatus comprising:
a liquid ejecting head having an ejection surface including a plurality of nozzle arrays in which a plurality of nozzles that eject liquid in an ejection direction are arranged in a nozzle array direction;
a transport mechanism that transports a medium in a first direction at a position facing the ejection surface; and
an air blowing mechanism, wherein
the nozzle array direction intersects both the first direction and a second direction orthogonal to both the first direction and the ejection direction, and
the air blowing mechanism generates an airflow along the ejection surface in a third direction intersecting all of the first direction, the second direction, and the nozzle array direction.

2. The liquid ejecting apparatus according to claim 1, wherein
the plurality of nozzles include a plurality of used nozzles that are used for a printing operation of ejecting the liquid toward the medium, and
when a line segment coupling the used nozzle disposed at an end in the nozzle array direction and the used nozzle disposed at an end in a direction opposite to the nozzle array direction in each of the plurality of nozzle arrays is defined as a nozzle line segment, the number of the nozzle line segments that overlap a virtual straight line projected on the ejection surface and extending in the third direction among a plurality of the nozzle line segments corresponding to the plurality of nozzle arrays is 1 or less.

3. The liquid ejecting apparatus according to claim 2, wherein
the plurality of nozzles include one or more unused nozzles that are not used for the printing operation, and
the virtual straight line overlaps any one or a plurality of unused nozzles among the one or more unused nozzles.

4. The liquid ejecting apparatus according to claim 2, wherein
all of the plurality of nozzles are the used nozzles that are used for the printing operation.

5. The liquid ejecting apparatus according to claim 2, wherein
the plurality of nozzle arrays include a first nozzle array and a second nozzle array that are adjacent to each other, and
when a straight line passing through a first used nozzle disposed at the end in the nozzle array direction among the plurality of used nozzles included in the first nozzle array and a second used nozzle disposed at the end in the direction opposite to the nozzle array direction among the plurality of used nozzles included in the second nozzle array is defined as a first straight line,
a first angle formed between the virtual straight line and the first straight line is equal to or less than half of a second angle formed between the first straight line and the nozzle line segment.

6. The liquid ejecting apparatus according to claim 5, wherein
the first straight line does not overlap the nozzle line segment other than the nozzle line segment corresponding to the first nozzle array and the nozzle line segment corresponding to the second nozzle array among the plurality of nozzle line segments.

7. The liquid ejecting apparatus according to claim 5, wherein
a distance between the first used nozzle and the second used nozzle is longer than a distance between a third used nozzle disposed at the end in the direction opposite to the nozzle array direction among the plurality of used nozzles included in the first nozzle array and a fourth used nozzle disposed at the end in the nozzle array direction among the plurality of used nozzles included in the second nozzle array.

8. The liquid ejecting apparatus according to claim 5, wherein
the liquid ejecting head constitutes a line head of which a longitudinal direction is the second direction, and
the nozzle line segment corresponding to the first nozzle array and the nozzle line segment corresponding to the second nozzle array constitute, among combinations of two nozzle line segments selected from the plurality of nozzle line segments, a pair having a greatest overlapping amount when viewed in the first direction.

9. The liquid ejecting apparatus according to claim 5, further comprising:
a carriage on which the liquid ejecting head is mounted and that reciprocates along the second direction, wherein
the nozzle line segment corresponding to the first nozzle array and the nozzle line segment corresponding to the second nozzle array constitute, among combinations of two nozzle line segments selected from the plurality of nozzle line segments, a pair having a greatest overlapping amount when viewed in the second direction.

10. The liquid ejecting apparatus according to claim 5, wherein
the first nozzle array and the second nozzle array are two nozzle arrays having a narrowest interval in a direction orthogonal to the nozzle array direction among the plurality of nozzle arrays.

11. The liquid ejecting apparatus according to claim 1, wherein
the liquid ejecting head constitutes a line head of which a longitudinal direction is the second direction,
the plurality of nozzle arrays are arranged in the second direction, and
two adjacent nozzle arrays among the plurality of nozzle arrays at least partially overlap each other when viewed in the first direction.

12. The liquid ejecting apparatus according to claim 1, further comprising:
a carriage on which the liquid ejecting head is mounted and that reciprocates along the second direction, wherein
the plurality of nozzle arrays are arranged in the first direction, and
two adjacent nozzle arrays among the plurality of nozzle arrays at least partially overlap each other when viewed in the second direction.

13. A liquid ejecting apparatus comprising:
a liquid ejecting head including a plurality of head chips each including a nozzle group including a plurality of nozzles that eject liquid in an ejection direction;
a transport mechanism that transports a medium in a first direction at a position facing an ejection surface of the liquid ejecting head; and
an air blowing mechanism, wherein the plurality of nozzles include a plurality of used nozzles used for a printing operation of ejecting the liquid toward the medium,
when a region surrounded by a smallest convex polygon surrounding the plurality of used nozzles in each of a plurality of the nozzle groups is defined as a nozzle region, a plurality of the nozzle regions corresponding to the plurality of nozzle groups are each elongated in a fourth direction intersecting both the first direction and a second direction orthogonal to both the first direction and the ejection direction, and
the air blowing mechanism generates an airflow along the ejection surface in a third direction intersecting all of the first direction, the second direction, and the fourth direction.

14. The liquid ejecting apparatus according to claim 13, wherein
the number of the nozzle regions that overlap a virtual straight line projected on the ejection surface and extending in the third direction among the plurality of nozzle regions is 1 or less.

15. The liquid ejecting apparatus according to claim 14, wherein
the plurality of nozzles include one or more unused nozzles that are not used for the printing operation, and
when a smallest convex polygon surrounding the one or more unused nozzles in each of the plurality of nozzle groups is defined as an unused region,
the virtual straight line overlaps one or a plurality of unused regions among the one or more unused regions.

16. The liquid ejecting apparatus according to claim 14, wherein
the plurality of nozzle groups include a first nozzle group and a second nozzle group that are adjacent to each other, and
when a straight line that is externally tangent to an end portion of the nozzle region corresponding to the first nozzle group in the fourth direction and an end portion of the nozzle region corresponding to the second nozzle group in a direction opposite to the fourth direction is defined as a second straight line,
a third angle formed between the virtual straight line and the second straight line is equal to or less than half of a fourth angle formed between the second straight line and a third straight line extending in the fourth direction.
